(19) United States
(12) Patent Application Publication
(10) Pub. No.: US 2011/0108063 A1
(43) Pub. Date: May 12, 2011

(54) PROCESS FOR DECONTAMINATING PRESERVATIVE-TREATED WOOD AND RECOVERING METALS FROM LEACHATES

(76) Inventors: Jean-Francois Blais, Beauport (CA); Guy Mercier, Quebec (CA); Patrick Drogui, Beauport (CA); Amelie Janin, La Chapelle Aux Naux (FR)

(21) Appl. No.: 12/736,455

(22) PCT Filed: Apr. 8, 2009
(86) PCT No.: PCT/CA2009/000447

§ 371 Date: Jan. 11, 2011

(30) Foreign Application Priority Data
Apr. 8, 2008 (CA) 2,628,642

(51) Int. Cl. B08B 7/04

(52) U.S. Cl. 134/10

(57) ABSTRACT

Described is a process for decontaminating wood treated with preservative such as chromium copper arsenate (CCA) including contacting the contaminated wood with water and inorganic acid at a concentration between 0.05 and 0.8 N at less than 100° C. to leach out the contaminants and then separate the wood from the solution. Also described is a process for extracting metals such as copper from a solution containing chromium, copper and arsenic, such as the leachate solution used to decontaminate CCA-treated wood, by precipitation using a coagulant at a pH favoring precipitation of arsenic and continued solubility of copper, or by ion exchange resins.

### FIELD OF THE INVENTION

The present invention generally relates to the wood treatment industry and more particularly to processes for decontaminating preservative-treated wood and extracting metal from contaminated solutions.

### BACKGROUND OF THE INVENTION

To increase wood lifetime, chemical treatments are often applied to particularly protect wood against insects and fungi. Many of the chemical preservatives are toxic to organisms and are consequently harmful if released into the environment.

Chromated Copper Arsenate (CCA), for example, has been commonly used for wood protection since the 70's. Arsenic and chromium are known to be toxic to humans and the environment and numerous studies have shown that leaching of metals occurs from in-service treated materials. Another problem arising from CCA-treated wood is that discarded CCA-treated wood containing high metals concentrations may still be defined by governmental organisations as non hazardous waste, resulting in its typical disposal into landfills despite the high susceptibility of metals leaching and dispersion. Based on today's in-service CCA-treated wood and expected service lifetime, it has been estimated that about 2.5 million m³ of CCA-treated wood wastes would be produced in Canada by 2020 and over 9 millions m³ in the United States by 2015.

There is currently and will continue to be a need for techniques for managing and recycling CCA-treated wood waste.

There are some known techniques for dealing with wood waste that has been treated with one or more preservatives such as CCA. Such techniques fall under the general categories of electrodialysis, thermal treatment, bioremediation, phyto-remediation and chemical remediation.

Electrodialysis has been used to extract metals from CCA-treated wood by applying an electric current on a mixture of acid solution and wood, causing metal ions to migrate through ion exchange membranes. One drawback of such techniques is the long length of time required for the reaction.

Thermal treatment such as incineration of CCA-treated wood can be a hazardous approach because of the volatilization of arsenic and the production of ash having high toxic metals contents. Other thermal methods such as treating CCA-treated wood using supercritical water to extract copper, chromium and arsenic are also known.

There have also been studies on bioremediation of CCA-treated wood using different fungal species. Some of these micro-organisms produce large quantities of oxalic acid capable of solubilising metals from CCA-treated wood and causing metal adsorption on the surface of the micro-organisms. Other bioremediation methods use inoculation CCA-treated wood containing with specific fungal cultures and other compounds, followed by aeration and hydration of inoculated wood. Phyto-remediation of treated wood using water jacinth (Eichhornia crassipes) has also been attempted, with limited success.

Chemical remediation offers the attractive possibility of both recycling the wood material and recovering the contaminant metals. When arsenic is one of the components of the preservative, however, it is usually not recovered due to its low value.

Chemical remediation techniques often aim to separate the wood from the metals and reverse the original preservative fixation mechanism. Table 1 generally summarizes various studies reporting chemical remediation of CCA-treated wood with different solvents.

TABLE 1
Extraction yields of As, Cr and Cu by chemical remediation

| | | | Metal | | | |
|---|---|---|---|---|---|---|
| Wood type | Solvent | Conditions | removal (%) | | | Author |
| West spruce | Oxalic acid (1 h, 1N) | H₂SO₄ (3 h, 1N) | 100 | 88 | 92 | Kakitani et |
| | | H₃PO₄ (3 h, 1N) | 98 | 77 | 75 | al. (2006b) |
| | | H₂SO₄ (3 h, 1N) | 100 | 90 | 88 | |
| | | H₃PO₄ (3 h, 1N) | 100 | 96 | 99 | |
| | | H₂O₂/NaOH (3 h, | 97 | 96 | 86 | |
| | | 3%/1%) | | | | |
| | | Ammonia (3 h, | 93 | 100 | 74 | |
| | | 10%, 15° C.) | | | | |
| | | NaHC₂O₄ (3 h, pH | 100 | 100 | 96 | |
| | | 3.2) | | | | |
| New treated | Sodium Bioxalate | | | | | Kakitani et |
| wood | | | | | | al. (2007) |
| chips | | | 94 | 89 | 88 | |
| New treated | EDTA/oxalic acid | Electrokinetic | 88 | 74 | 97 | Sarahney et |
| wood | | extraction | | | | al. (2005) |
| 3-year old | Oxalic acid | | | | | Clausen |
| wood | | | | | | and Smith |
| chips | | — | 42 | 14 | 16 | (1998) |
| sawdust | | — | 89 | 62 | 81 | |
| sawdust | | Bacillus | 100 | 79 | 99 | |
| | | licheniformis | | | | |
| New treated | H₂O₂ (10%, 50 | C., | 98 | 95 | 94 | Kazi and |
| pine | 6 h) | | | | | Cooper |
| | | | | | | (2006) |
| New treated | Oleic acid (pH 2, | | 97 | 78 | 97 | Gezer et al. |
| pine | 3 days) | | | | | (2006) |
| (2 × 2 × 2 cm) | | | | | | |
| Spruce and | Chitin (12.5 g/L, 10 | | 63 | 62 | 74 | Kartal and |
| pine | days) | | | | | Imamura |
| sawdust | Chitosan (12.5 g/L, | | 30 | 43 | 57 | (2005) |
| | 10 days) | | | | | |
| West spruce | H₂SO₄ (1N) | | 87 | 83 | 79 | Kakitani et |
| sawdust | H₃PO₄ (1N) | | 94 | 73 | 98 | al. (2004) |
| | and | | | | | |
| | Citric acid (1N) | | 63 | 50 | 70 | |
| | Oxalic acid (1N) | | 99 | 83 | 89 | |
| West spruce | Bioxalate (oxalic | | | | | Kakitani et |
| chips | acid 0.125M + | | 89 | 88 | 94 | al. (2006a) |
| sawdust | NaOH at pH 3.2) | | 100 | 92 | 91 | |
| New treated | Oxalic acid (1%, | EDTA (1%, 24 h) | 88 | 79 | 91 | Kartal and |
| pine | 24 h) | NTA (1%, 24 h) | 83 | 80 | 87 | Kose |
| chips | | EDTA (1%, 24 h) | 99 | 90 | 100 | (2003) |
| sawdust | | NTA (1%, 24 h) | 98 | 90 | 99 | |
| New treated | EDTA (1%, 24 h) | | | | | Kartal |
| pine | | | | | | (2003) |
| chips | | | 25 | 13 | 60 | |
| sawdust | | | 38 | 36 | 93 | |

In this regard, Kakitani et al. describe a process including a first leaching step with oxalic or citric acid followed by a second leaching step with an inorganic acid such as sulfuric or phosphoric acid, to leach the contaminants from the wood material. Some striking conclusions drawn by Kakitani et al. were that the inorganic acid caused significant wood damage and decomposition and produced wastewater containing significant organics. Kakitani et al. unequivocally concluded that sulfuric and phosphoric acids were unsuitable solvents ineffective for remediation of CCA-treated wood.

There are a variety of disadvantages challenges related to the known techniques for decontaminating preservative-treated wood. Some of them include organic content in the leaching wastewater, recoverability of the valuable metals such as copper, process efficiency and cost-effectiveness.

There is indeed a need for a technology that overcomes at least one of the disadvantages of what is known in the field.

### SUMMARY OF THE INVENTION

The present invention responds to the above need by providing a process for the decontamination of wood material containing wood-preservative contaminants.

Accordingly, the invention provides a process for decontamination of wood material contaminated with a preservative comprising contaminants, which include copper. The process comprises:
contacting the wood material with water and an inorganic acid at a concentration between about 0.05 N and about 0.8 N at a temperature lower than about 100° C., to solubilise at least a portion of the copper present in the wood material, thereby producing a contaminant-rich solution and contaminant-poor wood material; and
separating the contaminant-rich solution from the contaminant-poor wood material.

The present invention also responds to the aove need by providing a process for metals extraction from a contaminated solution.

Accordingly, the invention provides a process for selectively extracting copper from a contaminated solution comprising copper, chromium and arsenic, comprising:
contacting the contaminated solution with a coagulant at a pH favoring precipitation of the arsenic and continued solubility of the copper;
separating the precipitated arsenic and chromium to produce a copper-concentrated solution; and
recovering the copper from the copper-concentrated solution.

The invention also provides a process for selectively extracting copper from a contaminated solution comprising copper, chromium and arsenic, comprising:
contacting the contaminated solution with an ion exchange or chelating resin favoring both copper extraction and continued chromium and arsenic solubility, to produce a copper-bearing material and a chromium-arsenic-rich solution;
separating the copper-bearing material from the chromium-arsenic-rich solution; and
recovering the copper from the copper-bearing material.

### BRIEF DESCRIPTION OF THE DRAWINGS

FIG. 1 is a flowchart of the process according to an embodiment of the present invention.

FIG. 2 is a reaction scheme showing successive reactions during a five loop sequence of an embodiment of the process of the present invention.

FIG. 3 is a graph of As, Cr and Cu solubilization from CCA-treated wood after sulfuric acid leaching.

FIGS. 4a and 4b are graphs of As, Cr and Cu solubilization and extraction rate from CCA-treated wood after sulfuric acid leaching at various wood total solids concentration.

FIGS. 5a-5c are graphs of As, Cr and Cu solubilization from CCA-treated wood during sulfuric acid leaching at various temperatures.

FIG. 6 is a graph of metal concentrations versus DOC in leachates.

FIG. 7 is a flow diagram showing the mass balance of the leaching process for metals removal from CCA-treated wood.

FIG. 8 is a graph showing copper removal from CCA-treated wood leachates by electro-deposition.

FIG. 9 is a SEM picture of the black deposit on electrode, with picture size 1024×768 pixels, magnification: 2722.

FIG. 10 is a graph showing copper and arsenic removal comparison during electrodeposition (90 min, 10 A) of synthetic solutions.

FIGS. 11a-11c are graphs respectively showing arsenic, chromium and copper removal, in mono- and tri-metallic synthetic solutions by coagulation-precipitation with ferric chloride and NaOH ([FeCl₃]=3.75 mM/L).

FIG. 12 is a graph showing the effect of pH on arsenic, chromium and copper removal yields from CCA-treated wood leachates by coagulation-precipitation with ferric chloride and NaOH ([FeCl₃]=30 mM; decantation=24 h; sample collecting from supernatant).

FIG. 13 is a graph showing the effect of ferric chloride concentration on arsenic, chromium and copper removal yields from CCA-treated wood leachates by coagulation-precipitation with ferric chloride and NaOH (pH=7; decantation=24 h; sample collecting from supernatant).

FIG. 14 is a flow diagram showing a mass balance of the coagulation-precipitation process with ferric chloride and NaOH for metals removal from CCA-treated wood leachates. Operating conditions: pH=7, [FeCl₃]=20 mM, [Percol E10]=5 mg/L.

FIG. 15 is a graph showing the effect of pH on arsenic, chromium and copper concentration after CCA-treated wood leachate coagulation-precipitation with ferric chloride and Ca(OH)₂ or NaOH. Conditions: [FeCl₃]=17 mM; Initial concentrations: [As]=681.8 mg/L, [Cr]=697.7 mg/L, [Cu]=469.0 mg/L for Ca(OH)₂ precipitation and [As]=711.7 mg/L, [Cr]=720.8 mg/L and [Cu]=460.3 mg/L for Na(OH) precipitation.

FIG. 16 is a graph showing copper recovery from CCA-treated wood leachates by electro-deposition at various pH; Initial Cu concentration varies from 185 to 306 mg/L.

FIG. 17 is a graph showing coagulation-precipitation process followed by pH adjustment and electrochemical treatment for metals removal from CCA-treated wood leachates. Operating conditions: pH=4, [FeCl₃]=20 mM, [Percol E10]=5 mg/L.

FIGS. 18a-18d are graphs showing metals extraction capacities of resins M4195, IRC748, IR120 and 21XLT in leachates (24 h mixing, volume: 200 mL, pH 1.3).

FIG. 19 is a graph showing breakthrough curves of copper out of a series of 4 columns (C₀=456 mg/L; column volume=56 mL; BV=224 mL; [As]₀=608 mg/L; [Cr]₀=530 mg/L).

FIG. 20 is a graphs showing breakthrough curves of chromium out of a series of 4 columns (C₀=450 mg/L; column volume=56 mL; BV=224 mL; [As]₀=579 mg/L; [Cu]₀=5.1 mg/L).

FIG. 21 is a graph showing adsorption and elution profile of copper from M4195 resin and chromium from IR120 resin (BV=19.8 cm³; Flow rate=10 mL/min; feed (M4195)=25° C. leachate, H₂O and 4 M NH₄OH; Feed (IR120)=M4195 effluent, H₂O and 10% H₂SO₄).

FIG. 22 is a graph successive adsorption and elution profile of M4195 resin (Sequence=adsorption (Ads.) 30 min, rinsing 5 min, elution (Elu.) 30 min and rinsing 5 min; Adsorption feed=25° C. leachate, [As]0=608 mg/L; [Cr]₀=530 mg/L; [Cu]₀=456 mg/L; Elution feed=NH₄OH 4 M; flow rate=10 mL/min; BV=19.8 mL).

FIG. 23 is a graph successive adsorption and elution profile of IR120 resin (Sequence=adsorption (Ads.) 30 min, rinsing 5 min, elution (Elu.) 30 min and rinsing 5 min; Adsorption feed=M4195 effluents, [As]₀=579 mg/L; [Cr]₀=521 mg/L; [Cu]₀=5.13 mg/L; Elution feed=H₂SO₄ 10%; flow rate=10 mL/min; BV=19.8 mL).

FIG. 24 is a schematic for a process of successive IER and precipitation for treatment of CCA-treated wood leachates according to one embodiment.

FIG. 25 is a graph showing arsenic, chromium and concentration in acid leachate fraction of each five loops of a recirculation experiment.

FIG. 26 is a graph showing arsenic, chromium and copper solubilisation yield (%) during the leaching step of the five recirculation loops and linear regressions with maximum 100% values established according to the first loop AL_{L1} metals concentration of 686 mg As/L, 667 mg Cr/L and 403 mg Cu/L.

FIG. 27 is a graph showing dissolved Organic Carbon (DOC) content in Acid Leachate (AL) fraction and Precipitation Effluent (PE) fraction along the five recirculation loop.

### DETAILED DESCRIPTION OF THE PREFERRED EMBODIMENTS

Process embodiments of the present invention provide an effective and economical technique to remove contaminants from wood and to treat the resulting leachate solutions. In one optional aspect of the process embodiments of the present invention, they are used in relation to CCA-treated wood containing arsenic, chromium and copper.

### DEFINITIONS

“About”, when qualifying the value of a variable or property—such as concentration, temperature, pH, particle size and so on—means that such variable or property can vary within a certain range depending on the margin of error of the method or apparatus used to evaluate such variable or property. For instance, the margin of error for temperature may range between ±1° C. to ±5° C.

“Contaminated wood material” means a wood based material that may be in any state, shape or form powder, chip, pieces, logs, planks, compressed particle boards, plywood, and so on, which has at some time been treated with a wood preservative to thereby become “contaminated”. It should be understood that the contaminated wood material may be mixed with uncontaminated wood material at various point in the process in order to form an overall wood quantity to meet certain governmental or environmental standards.

“Preservative” means a compound for treating wood in order to increase its useful lifetime. Preservatives may include a fungicide component and an insecticide component to combat those two factors that so often lead to the deterioration of wood. There are many different types of preservatives that have been used to treat wood. The preservatives may have been impregnated deeply into the wood or provided substantially it the surface of the wood, depending on the regular practice of applying the given preservative.

“Inorganic acid” means an acid lacking a carbon atom and may be sulfuric, phosphoric, nitric or hydrochloric acid or a combination of such acids. It should also be understood that the inorganic acid may be a used or recycled acid.

“Contacting”, when pertaining to the contaminated wood and the inorganic acid and water, means that those elements contact each other so as to enable diffusion of the contaminants from the wood phase into the acid solution phase. The “contacting” will often be referred to as leaching herein and may include techniques such as soaking, batch mixing, trickling, spraying, continuous flow-by, or various combination of such contacting techniques.

“Separating”, when pertaining to the contaminant-rich solution and the contaminant-poor wood, means any suitable solid-liquid separation technique.

“Arsenic” (As), “chromium” (Cr) and “copper” (Cu), unless specified otherwise, each means a compound containing the given element and may include solubilised ions, complexes, derivatives, isomers, as the case may be. For instance, the term “chromium” may include chromium III and chromium VI; “arsenic” may include arsenate in association with CCA or solubilised in an aqueous medium; while “copper” may include the element in association with CCA, solubilised, or in its pure metallic form upon recovery. Thus, these elements should be read with a mind to their relationship with the process steps, process conditions and other interacting compounds.

“Contaminant-rich solution” means a solution containing the contaminants removed from the contaminated wood material during a leaching step. It should also be understood that for subsequent treatment of the solution to remove or recover contaminants, the contaminant-rich solution from the initial step may be combined with solutions from other leaching or washing steps to form an overall contaminant-rich solution. Thus, the contaminant-rich solution may be combined with other streams, diluted, concentrated, or be subjected to various other steps before it is treated to recover one or more of the contaminants.

### Embodiments of the Processes

In an optional embodiment of the process, it includes at least one inorganic acid leaching step to solubilize arsenic, chromium and copper from the CCA-treated wood, followed by at least one treatment step for the recovery of metals from the acid leachates resulting from the leaching and washings steps. The decontaminated wood and the metals extracted from the wood may be safely disposed or recycled.

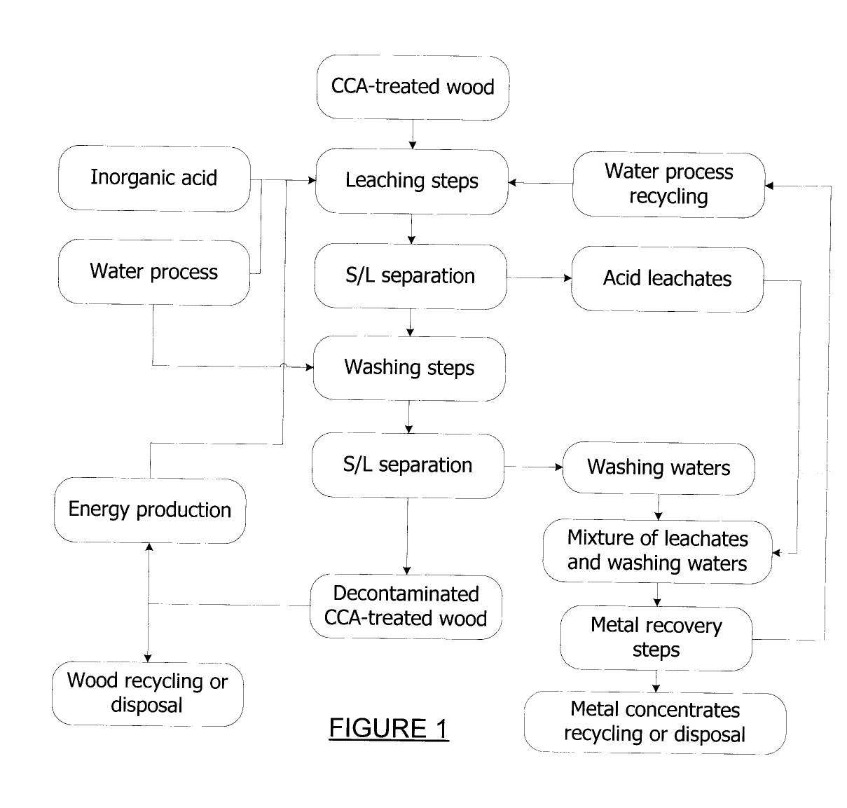

FIG. 1 shows a flow diagram of the various stages of one embodiment of the process.

According to an embodiment of the present invention, the first phase of the process includes contacting the wood material with water and an inorganic acid at a concentration between about 0.05 N and about 0.8 N, preferably between about 0.1 N and about 0.5 N, and still preferably at about 0.2 N, at a temperature lower than 100° C., to solubilise at least a portion of the copper present in the wood material, thereby producing a contaminant-rich solution and contaminant-poor wood material. This contacting step may also be called a primary acid leaching step. More particularly, this leaching step includes acidification of CCA-treated wood by a mixture of an inorganic acid and water.

Before this leaching treatment, CCA-treated wood can be crushed, chopped or shredded, so as to obtain for instance wood particles having a size inferior to about 5 cm, preferably inferior to about 1 cm, and still preferably between about 0.5 mm and about 1 cm.

According to one embodiment of the process, the wood particles content of the mixture is adjusted to a range between about 20 and about 200 g/L of solution.

In one optional embodiment of the present invention, the inorganic acid is sulfuric acid and is added so as to obtain an acid concentration ranging between about 0.05 and about 0.8 N. The inorganic acid used as a leaching agent may be hydrochloride acid, nitric acid, sulfuric acid, used acid, recycled acid or a combination thereof. The choice of inorganic acid may be made in order to facilitate chemical complexation in later process steps. For instance, as will be explained in detail below, the use of sulfuric acid will allow precipitation of calcium sulfates when calcium hydroxide is used for downstream coagulation.

The acidic solution is then mixed for a period sufficient to adequately solubilize toxic metals present in the contaminated wood material. Typically, this period ranges from about 0.5 to about 24 hrs.

The mixture is maintained at a temperature below about 100° C. According to one optional aspect of the invention, the temperature may range between about 20° C. and about 80° C.

There may also be a single leaching step or several sequential steps that employ the same or different acids and concentrations of the acids. The leaching steps can be operated in batch, semi-continuous or continuous mode in tank reactors.

After the leaching steps, the wood particles are separated from the solution, thereby obtaining the contaminant-poor wood material and the contaminant-rich acid leachate. When the preservative is CCA, the acid leachate contains high concentrations of arsenic, chromium and copper. The separation of wood particles from the liquid fraction can be done by decantation, filtration, centrifugation, or another other standard technique of solid-liquid separation.

According to an embodiment of the present invention, there is a second phase of the process including washing of the wood particles to remove residual solubilised metals. The washing of the wood particles can be done by rinsing the solids resulting from a previous filtration step or by mixing the solids re-suspended in the washing solution, followed by a step of solid-liquid separation. The washing of the wood particles can be done in one or more steps with water, a dilute acid solution, or an alkaline solution. The different washing steps may be performed with the same or different washing solutions. The acid leachates from the first phase and the spent washing liquids may then be combined to obtain a solution containing the totality of the target contaminants, for example the totality of the arsenic, chromium and copper extracted from the CCA-treated wood. Some or all of the washing waters can also be directly used as process water for the operation of the initial leaching steps for a subsequent batch or quantity of contaminated wood. More regarding process water recirculation will be discussed hereinbelow.

According to an embodiment of the present invention, the process may also have a third phase including treating the acid leachates, the spent washing liquids or a combination of these solutions, to recover at least one of the contaminants. The combination of the acid leachates and the spent washing liquids will be generally referred to here as the “contaminant solution”, which contains the solubilised contaminants. It should be understood however that the solution treated to recover solubilised metals may be the acid leachate or the spent washing liquid only. When CCA-treated wood has been subjected to the first and second phases of the process, the contaminant solution contains solubilised arsenic, chromium and copper. The metal recovery from the solution includes one or a combination of the following techniques: chemical precipitation, electrodeposition, electrocoagulation, ion exchange, solvent extraction, membrane separation and adsorption. After the contaminated solution has been treated to remove the metals, it may for example be used as process water for the operation of the leaching steps.

By way of example, in one optional embodiment of the process, elemental copper)(Cu⁰) is recovered by electro-deposition on cathodes, trivalent chromium ions are separated and concentrated on a strong acid cationic exchange resin, and hexavalent chromium ions and arsenic are separated and concentrated on a strong base anionic exchange resin.

In another optional embodiment of the process, copper ions are firstly concentrated on a chelating resin and, after elution, elemental copper is recovered by electro-deposition.

In a further optional embodiment of the process, the precipitation of the arsenic ions may be done by electro-coagulation using iron or aluminum soluble electrodes.

In another optional embodiment of the process, copper, chromium and arsenic may be simultaneously removed from the solution by a total precipitation technique using an iron salt (e.g. ferric chloride or sulfate) with a strong base (e.g. caustic soda or lime), or by an electro-coagulation technique.

In another optional embodiment of the process, arsenic and chromium may be firstly precipitated and separated using a ferric salt, and then copper may be deposited on electrodes by electro-deposition.

The decontaminated wood particles and the metals extracted from the contaminated wood can be safely disposed of or recycled. The energy that may be required or desired to heat the mixture of wood particles and acid solutions may be provided by burning a part of the decontaminated wood particles. The decontaminated wood material may also be used as an energy source by subjecting it to gasification to produce syngas and eventually ethanol and other types of bio-products by various known techniques, or by converting it to bio-oils by known techniques.

Embodiments of the present invention provide a number of advantages. Advantages will be understood as per the above and the examples and experimental data obtained through the extensive studies presented below.

For instance, the use of inorganic acid, such as sulfuric acid, allows good metal solubilization yields from CCA-treated wood at a low chemical cost. The mild acidic conditions applied during the leaching steps solubilise toxic metals, but do not significantly destroy the organic matter of the CCA-treated wood. In fact, the concentration of organic carbon in the leachates and washing waters is relatively moderate. The mild acidic conditions for leaching also reduce the quantity of base in subsequent process steps such as metals recovery, precipitation, coagulation, etc., as will be appreciated in the below examples. The relatively low temperature (<100° C.) used during the operation of the leaching steps can be reached at low energy cost. Moreover, the energy requires to heat the acid solutions can be generated by burning a part of the decontaminated wood particles. Furthermore, the addition of at least one washing step after the leaching steps is useful to remove the dissolved metals still present in the wood particles. In addition, the treatment of the acid leachates and washing waters containing high concentrations of contaminants such as arsenic, chromium and copper metals, allows recovery of metals and the possibility of their recycling, particularly copper and chromium, in the industry.

### Examples, Experimentation & Additional Information

The embodiments of the present invention will be further comprehended and elaborated in light of the following examples and results, which are to be understood as exemplary and non-limiting to what has actually been invented. Though the examples were conducted on CCA-treated wood in particular, embodiments of the present invention may be used to decontaminate and recover metals from wood treated with other types of preservatives such as ammonium copper zinc arsenate (ACZA), alkaline copper quaternary ammonium (ACQ), copper azole (CA), chromated copper arsenate (CCA), copper borate (ACB), copper xyligen (CX-A), micronized copper systems (MiCu), or a combination of such preservatives. For such preservatives, copper may be both solubilised for removal from the wood and then recovered as a valuable metal.

### General Methodology

The following describes the general methodology of examples of an embodiment of the process of the present invention.

Wood Characterization

Metals concentrations in CCA-treated wood were determined by ICP-AES after digestion with analytical grade nitric acid (50% w/w, 20 mL) and hydrogen peroxide (30% w/w, 10 mL). A mass of 1.0 g of dry wood was used for wood digestion.

The metals availability in CCA-treated wood was estimated by two standard leaching tests, TCLP and SPLP, and another test called the “Tap water test”. For all three tests, 50 g of wood were placed in 1 L plastic bottles filled up with solvents. Solvents are diluted acetic acid solution for the TCLP test, diluted sulfuric and nitric acid for the SPLP test, and tap water for the last test. After bottle rotation for 24 hrs and then filtering, the remaining acid solutions were analyzed for As, Cr and Cu concentrations.

Wood Decontamination

The wood decontamination examples were conducted to determine the efficient and economical design and operation of an embodiment of an acid leaching process to remove, for example, As, Cu and Cr from CCA-treated wood.

In one example related to the first phase of the process, two inorganic acids (sulfuric and phosphoric acids), one organic acid (oxalic acid), one oxidizing agent (hydrogen peroxide) and one complexing agent (EDTA) were tested as extracting reagents. Leaching solutions were prepared with analytical grade reagents diluted in deionised water. A mass of 10 g of sieved wood (2 to 8 mm) was mixed with 200 mL of leaching solution in a 500 mL baffled shaker flask (Cole Parmer, Montreal, Canada). The flasks were placed into an oscillating shaker at 200 rpm for 24 h at 25° C. Liquid-solid separation was performed by vacuum filtration on Whatman 934-AH glass fiber membranes. All glassware was thoroughly washed.

Further studies were performed on a broad range of acid concentration. The improved acid condition was kept constant for the subsequent experiments. Other studies were performed on the solid (wood) content, kinetic studies were conducted at various temperatures and the influence of wood granulometry was also evaluated.

Leaching Balance and Decontaminated Wood Characterization

In order to assess the leaching process, final tests have been done with measurements of all inputs and outputs. The leaching operation included three leaching steps plus one, two or three washing steps. Wood samples were weighed before and after leaching treatment. For each wood sample, water content was calculated by measuring the weight before and after drying in oven at 105° C. for 24 h. Volumes and metals concentrations in leachates were also measured. Metals concentrations in wood were determined as well before and after the leaching treatment.

Electrochemical Treatments

The electrochemical treatments were conducted using a batch electrolytic cell made of acrylic material with a dimension of 12 cm (width)×12 cm (length)×19 cm (depth). The electrode sets (anode and cathode) consisted of eight parallel pieces of metal plates each, having a surface area of 220 cm², situated 1.5 cm apart and submerged in the wood leachate. Titanium coated with oxide iridium (Ti/IrO₂) was used as anode, whereas stainless steel (SS, 316 L) was used as cathode. Four anodes and four cathodes alternated in the electrode pack. The electrodes were installed on a perforated acrylic plate placed 2 cm from the bottom of the cell. Mixing in the cell was achieved by a Teflon-covered stirring bar installed between the perforated plate and the bottom of the cell. A working volume of 1.8 L was used for all experiments. Samples of 10 mL were drawn after 10, 20, 30, 40 and 60 minutes and monitored for pH and residual metal concentrations. Between two assays, electrolytic cells (including the electrodes) were cleaned with 5% (v/v) nitric acid solution and then rubbed with a sponge and rinsed with deionised water. The anode and cathode sets were connected to the negative and positive outlets of the DC power supply Xantrex XFR40-70 (Aca Tmetrix inc., Mississauga, Canada). The current intensity imposed varied from about 0 to about 10 A. The current intensity was held constant for each run with a retention time of about 90 min. The electric current was divided between all the electrodes.

For further experiments intended to evaluate copper-arsenic interaction during electro-deposition, synthetic solutions were made using As₂O₅ and CuCl₂ in deionised water with sulfuric acid or hydrochloric acid.

Chemical Precipitation and Coagulation

For experiments designed to measure soluble metals along the 1.5 to 12 pH range, volumes of 1 L of leachates were used and 5 mL samples were drawn at approximately 0.5 pH intervals. The pH was raised up by adding sodium hydroxide solution (2.5 M) drop wise. Before each sample withdrawal pH was allowed to stabilize for 5 to 10 min to ensure proper readings of the pH value.

Coagulation experiments occurred in 100 or 250 mL beaker with magnetic stirring at 100 rpm using a Teflon-covered bar. Leachate pH was initially stabilized to the appropriate pH by adding sodium hydroxide solution (2.5 M). Then, ferric chloride solution (FeCl₃ in hydrochloric acid media) was added into the 50 or 200 mL leachates. The pH was re-adjusted after ferric chloride addition. Solutions were mixed together at 250 rpm for 30 min, then settled down for 24 h. The supernatant was collected and filtrated on Whatman 934AH membranes for further soluble metals analysis. Iron solution was made by dissolving ferric chloride salts (FeCl₃) in deionised water at 45.91 g Fe/L with pH inferior to 1 due to hydrochloric acid addition or industrial ferric chloride solution from Environment EagleBrook Canada Ltée (Varennes, Canada) containing 160 g Fe/L. Iron concentration was calculated from the added ferric solution volume.

For further understanding of metals interactions during precipitation-coagulation experiments, synthetic solutions were made with 1, 2 or 3 of the considered CCA metals. Those solutions were made by dissolving As₂O₅, CrCl₃ and CuCl₂ in deionised water acidified with hydrochloric acid. Metals concentrations and pH of the synthetic solutions were adjusted to the same values which were measured in the wood leachates.

For flocculation experiments, solid Percol E10 was dissolved in deionised water at 1 g/L. As ferric chloride addition and pH adjustment were done, known volume of Percol solution was added while gently stirring for 2 min. Upcoming sludge was then filtered through Whatman 934AH glass fiber filters or settled down for 24 h.

Chemical Coagulation Balance

In order to assess coagulation experiments, final tests were done by measuring inputs and outputs during coagulation. Volumes of leachates and effluents were measured as well as metal concentrations. Water content in sludge was determined by comparing weight before and after overnight drying at 105° C. Metal content in sludge was obtained by digesting 0.2 g of solid with 20 mL HNO₃ 50%.

Chemical Coagulation Followed by Electrodeposition

Tests were conducted with pH 4 coagulation followed by electro-deposition. To simplify laboratory procedure, leachates employed for these experiments were made at 25° C. for 24 h instead of 75° C. for 6 h. Coagulation parameters were as follow: [FeCl₃]=20 mM; [Percol]=5 mg/L, whereas electro-deposition parameters were: time=90 min, Intensity=10 A. Between coagulation and electro-deposition steps, pH was adjusted by addition of sulfuric acid.

Ion Exchange Resin

Experiments regarding ion resin exchange assessed the potential of ion exchange resin (IER) for selective recovery of contaminants. Four IER were chosen for their various functional groups. Resins Amberlite IRC748 (Rohm & Haas, USA) and Dowex M4195 (Dow Chemicals, USA) are both chelating resins, with respectively iminodiacetic acid and bis-picolylamine active groups. M4195 resin has been developed especially for copper scavenging. IR120 (Rohm & Haas, USA) resin is a strong cationic exchange resin with onic groups whereas resin Dowex 21KXLT (Dow Chemicals, USA) resin is a strong anionic resin with quaternary amine groups.

Experiments were firstly conducted in batch mode. Variable volumes of resin were mixed with 200 mL CCA-treated wood leachate in 500 mL Erlenmeyer flasks and stirred at 150 rpm for 24 h to ensure that chemical equilibrium was attained. Thereafter, liquid to solid separation was made by filtration onto Whatman 934AH filter.

Column experiments were conducted using Plexiglas tubes (19 mm diameter and 210 mm height) and were filled with resin, which was retained inside using glass wool supported by perforated plastic disks at both ends of the column. Maximum bed volume of single column was 56 cm³. To allow for optimum flow properties, resins were first backwashed for 15 min with acidified water at 30 mL/min. The sorbent bed expanded and then settled down gently by decreasing the flow rate. Feed solution was then introduced at the bottom of the column. The inlet flow rate was set at 10 mL/min using a peristaltic pump. The flow rate at the outlet of the columns was monitored by measuring the liquid volume during a known period of time. Series columns were connected using Masterflex 6424-17 tubing (Cole Parmer, Montreal, Canada). Taps were installed in between the columns so as to be able to sample effluent from each individual column. Each column resin bed had a capacity of 56 cm³, hence total resin bed volume in the system was 224 cm³. Sampling was made either by collecting small effluent aliquots at known time intervals at the outlet of columns or by collecting the entire amount of effluent over a known time period. This procedure allowed for instantaneous plotting of the metal concentration in the outlet solution while simultaneously measuring the overall quantities of metals able to go through the columns without retention. These column experiments were conducted either with original feed or with M4195-pretreated 25° C. leachate. M4195-pretreated leachates were prepared by circulating leachate at 25° C. through a series of four M4195 columns in order to remove copper from the leachate. The copper concentration in M4195 effluent was measured and used for IR120 column experiments for copper concentrations lower than 10 mg/L.

Elution of resins M4195 and IR120 was conducted respectively with NH₄OH (4 M) and H₂SO₄ (10%) in columns. As for adsorption, elution reagents were fed from the bottom of the column at 10 mL/min and samples were collected from the outlet of each column every 3 or 5 min.

To assess the extraction capacity of M4195 and IR120 ion exchange materials after successive regeneration, a sequence of five cycles including a 30 min adsorption phase and a 30 min elution phase were conducted with half-filled columns (Bed volume=19.8 mL). Distilled water was circulated through the columns for 5 min in between the adsorption and elution phases. Hence, filling the column with water prevented undesired reactions between the leachate and elution reagent. The 25° C. leachate was fed into the M4195 column during the adsorption phase and the NH₄OH (4 M) solution fed into this column during the regeneration phase. In a similar fashion, the IR120 column feed was M4195-pretreated leachate during the adsorption phase and sulfuric acid (10%) during the elution phase.

Consequently, the feed solution during one cycle of adsorption-elution was as follows: leachate (30 min), water (5 min), elution reagent (30 min), water (5 min). During the experiments, a total of five successive cycles were carried out. Samples were withdrawn at the outlet of the columns at 3 or 5 min intervals. Furthermore, the adsorption phase effluent and the elution phase effluent were kept for calculation of the total metal uptake and release by the sorbent media.

Effluent Recirculation

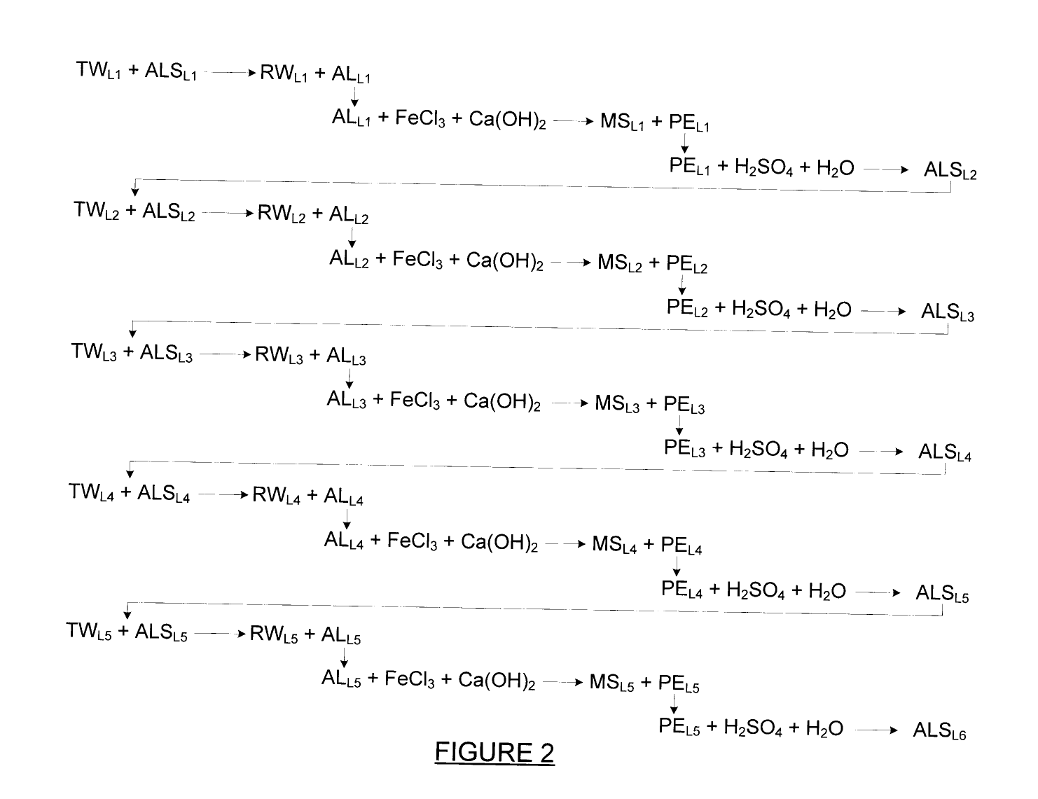

The aim of precipitation effluent recirculation back to the leaching step was to decrease water need and effluents output, hence to reduce the process costs. Once precipitation with sodium hydroxide was improved, recirculation experiments were conducted using both improved leaching conditions and improved precipitation conditions (determined in the first part of this study). The five leaching loops are named L1, L2, L3, L4 and L5. 210 g of treated wood (TW_{L1}) is equally shared between the seven leaching flasks individually containing 200 mL of distilled water and 1.1 mL of concentrated sulfuric acid because our oscillating shaker cannot hold larger flasks. After this, the seven contents were mixed together and filtered to produce the Remediated Wood fraction (RW_{L1}) and Wood Leachate fraction (WL_{L1}). WL_{L1} volume was measured and appropriate volume of FeCl₃ and Ca(OH)₂ solutions were added to the leachate to undergo precipitation. Precipitation was conducted in a 2000 mL beaker at 40° C. with 19 mM FeCl₃. The mixture was then filtered to produce the Metallic Sludge fraction (MS_{L1}) and Precipitation Effluents fraction (PE_{L1}). PE_{L1} volume was measured. Effluent Acidification (EA) step consists of addition of 7.7 mL concentrated sulfuric acid to PE_{L1} and addition of distilled water to adjust volume to 1400 mL to produce the 2^{nd} loop Acid Leaching Solution (ALS_{L2}). ALS_{L2} was separated in seven 200 mL fractions to undergo leaching step with a new CCA Treated Wood fraction (TW_{L2}). These operations were repeated four more times to complete the five loop recirculation experiment. This five loop sequence is summarised in FIG. 2.

Analytical Techniques

The pH was determined using a pH-meter (Fisher Acumet model 915) equipped with a double-junction Cole-Palmer electrode with Ag/AgCl reference cell. Metals concentrations were measured by an ICP-AES (Varian, model Vista-AX). Quality controls were performed with certified liquid samples (multi-elements standard, catalogue number 900-Q30-002, lot number SC0019251, SCP Science, Lasalle, QC, Canada) to ensure conformity of the measurement apparatus. The TS concentrations were determined according to method 2504B (APHA 1999). The DOC is measured by a Shimadzu TOC-5000A apparatus. Structural analysis of the electrode deposit has been studied using EVO50 scanning electron microscopy (SEM) from Zeiss (Germany) equipped with INCAx-sight energy dispersive spectrometer (EDS) from Oxford Instruments (United Kingdom).

Economic Aspect

The chemical costs associated to the decontamination of CCA-treated wood have been calculated on the basis of the following unitary prices. The sulfuric acid (solution at 93% w/w) was evaluated at a cost of 100 US$/t. The hydrogen peroxide (solution at 50% w/w) was estimated at a cost of 800 US$/t and the oxalic acid (99.6% pure powder) was calculated at a cost of 500 US$/t.

### Example 1

### Selection of the Leaching Reagent

Five “extractants” were tested for metal extraction from wood at five different concentrations in the range 0.002 to 0.07 N for sulfuric acid, 0.005 to 0.06 N for phosphoric acid, 0.002 to 0.07 N for oxalic acid, 1 to 20 g EDTA/L, and 0.1 to 10% for hydrogen peroxide. Overall, the higher the reagent content the better the extraction yield, except in the case of EDTA. Between 5 and 20 g EDTA/L metals concentrations in the leachates remain stable with less than 20% of As and 4% of Cr removed from CCA-treated wood. Table 2 presents the results of extraction experiments with the highest concentrations tested of the five leaching reagents. Sulfuric acid, oxalic acid and hydrogen peroxide gave the highest metals removal yields.

TABLE 2
Maximum yields of metals extraction (%) by leaching*

| | H₂SO₄ | H₂O₂ | H₃PO₄ | EDTA | Oxalic acid |
|---|---|---|---|---|---|
| Metals | 0.07N | 10% | 0.06N | 20 g/L | 0.07N |
| As | 67.3 | 71.2 | 31.1 | 19.7 | 79.9 |
| Cr | 48.2 | 57.7 | 11.0 | 3.5 | 61.2 |
| Cu | 100.0 | 82.7 | 92.6 | 99.7 | 49.3 |

Note:
Leaching conditions: wood content = 50 g/L, T = 25° C., reaction time = 22 h, particle size = from 0.5 to 2 mm.
*Highest concentrations tested at this stage.

In order to design a remediation process, performance and cost are two principal criteria in terms of leaching reagents. Regarding the costs, it was obvious that hydrogen peroxide is too costly to be used for CCA-treated wood decontamination. In fact, a concentration of 2 219 kg H₂O₂/t of wood would be required to reach 60% of As concentration. This corresponds to a cost of 3,550 $/t of wood. In comparison, only 48 kg oxalic acid/t and 80 kg sulfuric acid/t would be required to reach the same level of As solubilization. The corresponding costs would be respectively 24 and 8 $/t of wood. The cheapest reagent was sulfuric acid, but at the initial stage of experimentation, it did not allow more than 67% removal yield for As. (TKTKTK)

### Example 2

### Effect of the Leaching Reagent Concentration

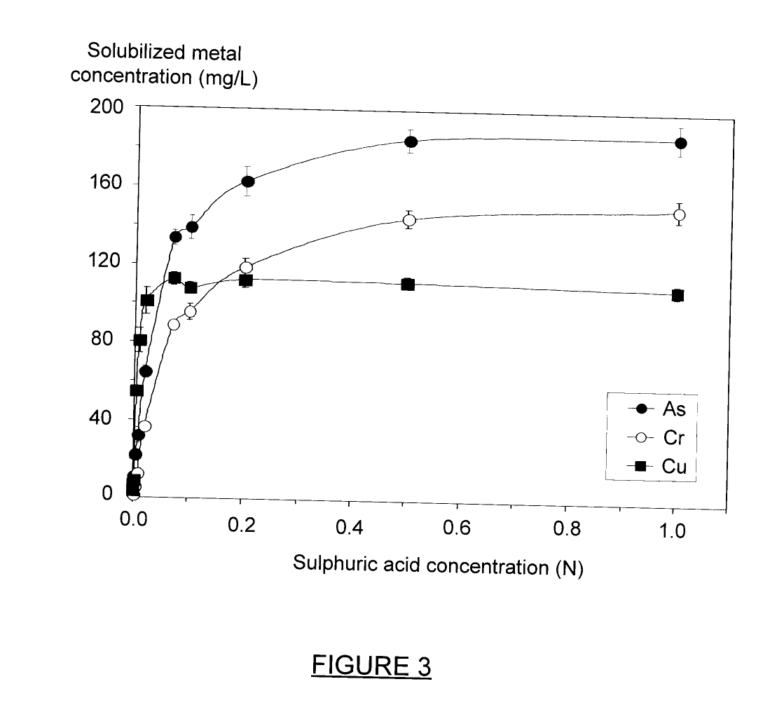

Sulfuric acid content in the leaching solution was improved. Leaching experiments were conducted with different acid concentrations (0.002 to 1 N). FIG. 3 shows As, Cr and Cu concentrations in leachate versus acid concentration, at leaching conditions: wood content=50 g/L, T=25° C., reaction time=22 h, wood particle size from 0.5 to 2 mm.

Increasing the acid concentration raises the metal extraction, but it can be seen that between 0.5 and 1.0 N, metal extraction is not improved. Metals leaching attain a maximum at 187 mg As/L, 151 mg Cr/L and 109 mg Cu/L corresponding respectively to 100%, 87% and 100% extraction yields. Therefore, at 1.0 N sulfuric acid seems to solubilise the entire content of As and Cu, but leaves less than 13% Cr in the remaining wood.

Gain in metals extraction is relatively low for increasing cost when acid concentration exceeds 0.2 N. Therefore, 0.2 N sulfuric acid is a good compromise between performances and low costs and corresponds to 20 $/t of dry wood with 5% total solids (TS).

### Example 3

### Effect of Total Solids (TS) Concentration

The TS content is an important parameter as it influences capital costs by varying the size of the leaching reactor. Leaching tests were done with 2.5, 5.0, 10, 12.5 and 15% wood content. FIGS. 3a and 3b show As, Cr and Cu solubilization and extraction rate from CCA-treated wood after sulfuric acid leaching at various wood total solids concentration at leaching conditions: 0.2N H₂SO₄, T=25° C., reaction time=22 h, wood particle size from 0.5 to 2 mm. Note that 15% TS was the maximal concentration tested being the largest wood volume able to sink into 200 mL; over this value, part of the wood would stay dry and untreated by the leaching solution.

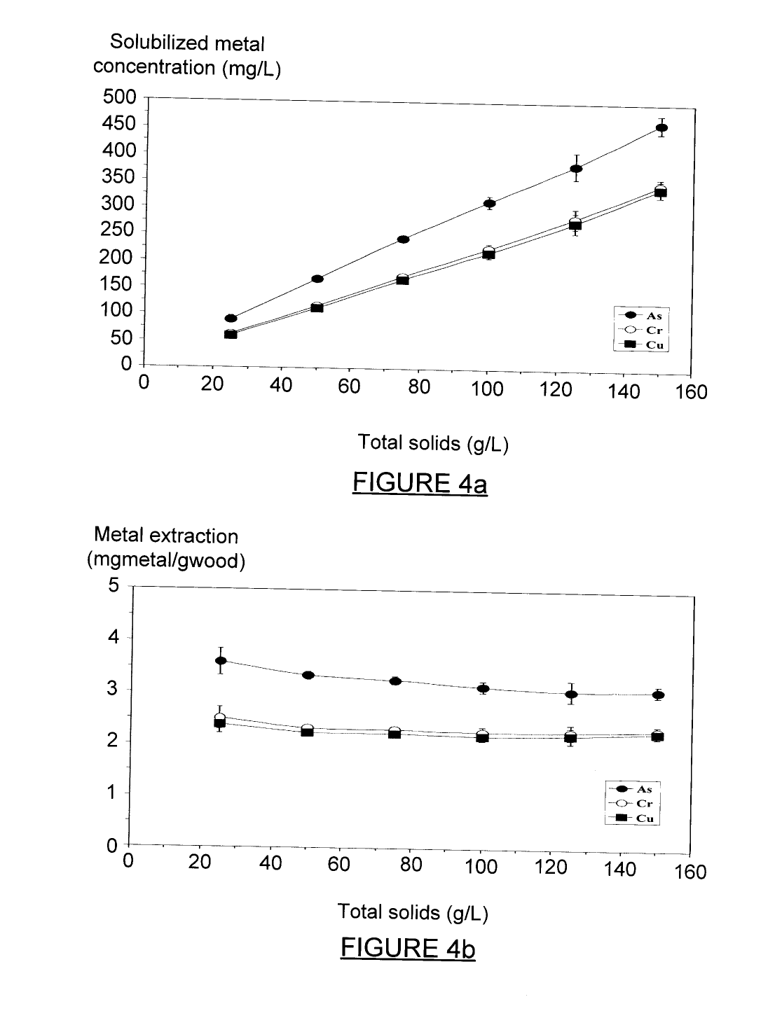

The more wood in reactor, the more metals are found in leachates. With 15% TS, concentrations in leachates reach respectively 463 mg As/L, 348 mg Cr/L and 342 mg Cu/L. At this step, it is interesting to look at removal yields versus solid content. As reported by the FIG. 4b, extraction yield stays stable over the solid content range meaning that, in these conditions, the extraction efficiency does not depend on wood content. TS content is then set up to be 15% or 150 g of wood/L during metal extraction using sulfuric acid.

### Example 4

### Effect of Temperature and Reaction Time

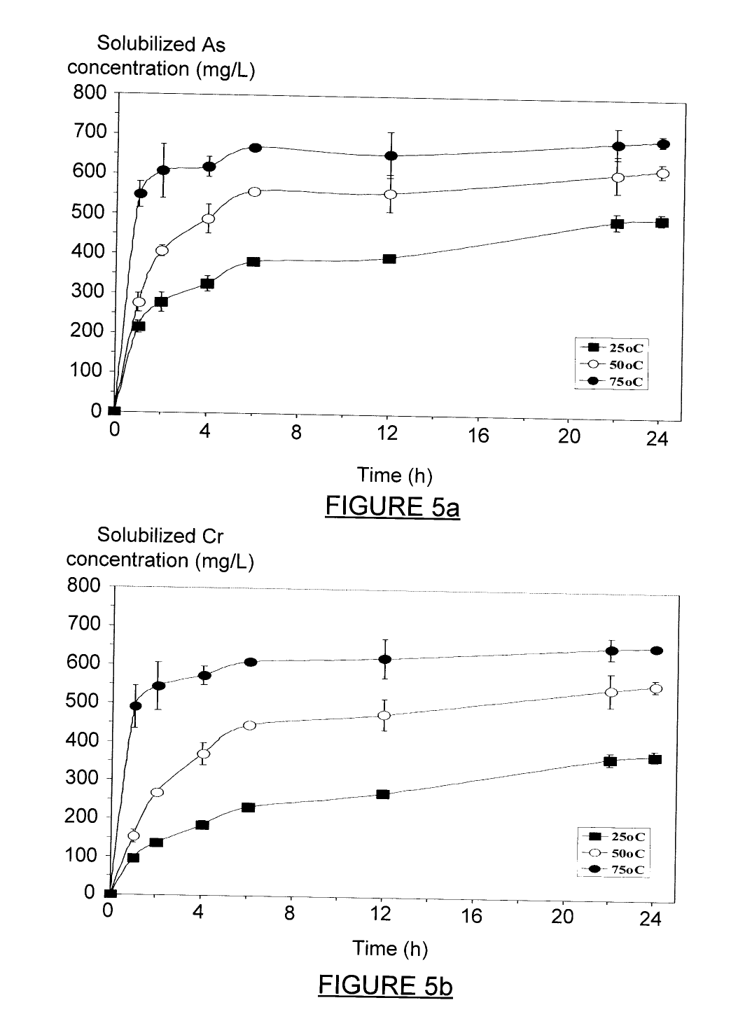

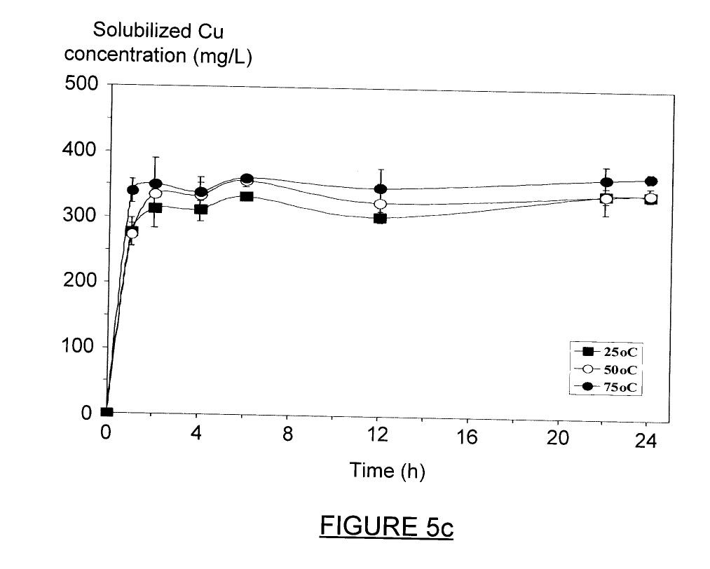

Temperature and retention time are significant parameters in chemical processes. To assess influence of these variables, kinetics tests were done at three different temperatures: 25, 50 and 75° C. Sampling was done after 1, 2, 4, 6, 12, 22 and 24 h. The results are presented in FIG. 5. The leaching conditions for this: wood content 150 g/L, 0.2N H₂SO₄, and wood particle size from 0.5 to 2 mm.

Cu is not so much influenced by temperature whereas As and Cr extraction seem to be especially sensitive to heat. As it can be seen on the graphs, the high temperature speeds up the metals' solubilization from the wood and increases the extraction yield.

At 75° C. metal extraction is particularly fast during the first 120 min and the reaction is almost completed after 6 h (FIGS. 5a-5c). Therefore, even if higher temperatures cause high operational costs, it is decided to operate the leaching at 75° C. for 6 h. In these conditions, metals concentrations in leachate reach 697 mg As/L, 658 mg Cr/L and 368 mg Cu/L.

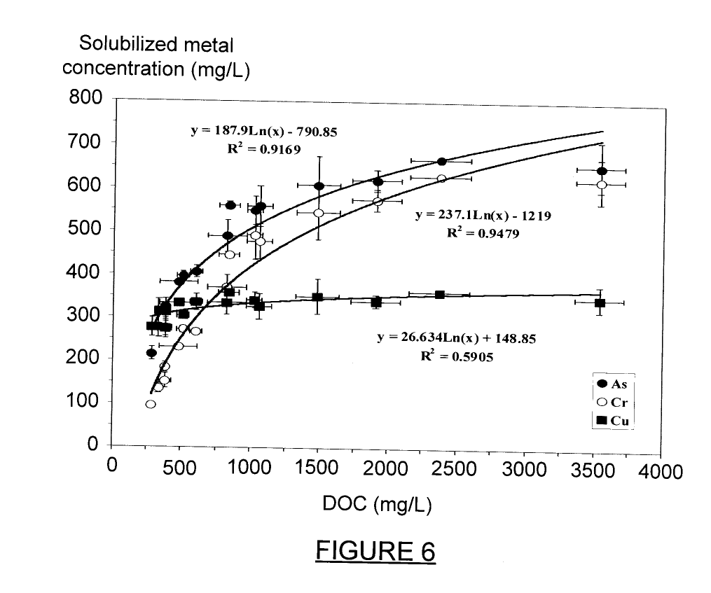

Dissolved Organic Carbon (DOC) was also measured to evaluate the effect of acid treatment at the different temperatures on the wood structure. DOC concentration after 6 and 12 h at 25, 50 and 75° C. are shown in Table 3. The increase in temperature greatly increases the DOC release during leaching. Furthermore, FIG. 6 shows the effect of acid concentration over DOC release during leaching at 25 and 75° C. An increase in sulfuric acid concentration tends to elevate the DOC release at 75° C., meaning that acid undergoes wood solubilization as well as metal solubilization. In this regard, two mechanisms can coexist. Acid can split apart the lignin-metal bonds or it can break up the wood structure by splitting lignin-lignin bonds. By plotting metal concentration in leachates versus DOC, as shown in FIG. 6, it appears that the values are fairly proportional (particularly for As and Cr). It could be that a portion of the acid breaks apart the wood structure and solubilises organic matter onto which metals are bonded to. The leachate conditions for the data of FIG. 6 were: wood content=150 g/L, 0.2N H₂SO₄. T=75° C., wood particle size from 0.5 to 2 mm.

TABLE 3
DOC concentrations in leachates at various temperatures

| | DOC (mg/L) | | |
|---|---|---|---|
| Reaction time | 25° C. | 50° C. | 75° C. |
| 6 | 475 ± 138 | 835 ± 71 | 2,369 ± 221 |
| 12 | 506 ± 45 | 1,056 ± 94 | 3,534 ± 178 |

Note:
Leaching conditions were: wood content = 150 g/L, 0.2N H2SO4, T = 75° C., particle size = from 0.5 to 2 mm.

### Example 5

### Effect of Wood Particle Size

The above tests were performed with 0.5 to 2 mm chopped and grinded wood. This next test intended to experiment acid leaching with different wood particle sizes. Grinded wood was separated into a 0.5 to 2 mm fraction and a 2 to 8 mm fraction. Because of the laboratory grinder, the wood resembles little cylindrical woody pieces. In another case, wood was chopped and screened using a 8 mm sieve but not grinded by the laboratory grinder. This wood resembles fine squares. In addition, the wood pieces do not look the same depending on the way they are cut. Table 4 presents results of leaching with grinded and ungrinded wood.

TABLE 4
Metals solubilization (mg/L) from grinded and ungrinded wood

| | Grinded | Grinded | Ungrinded |
|---|---|---|---|
| | wood | wood | wood |
| Metals | 0.5 to 2 mm | 2 to 8 mm | <8 mm |
| As | 572 ± 32 | 460 ± 15 | 647 ± 16 |
| Cr | 551 ± 29 | 437 ± 17 | 629 ± 16 |
| Cu | 316 ± 17 | 254 ± 11 | 360 ± 9 |

Note:
Leaching conditions: wood content = 150 g/L, 0.2N H₂SO₄, T = 75° C., reaction time = 6 h.

For grinded wood, metal extraction was greater when particle size was smaller. This was expected as the smaller the wood piece, the greater the active surface which promotes the leaching reaction. Metals concentrations in leachates were 1.2 times greater with 0.5 to 2 mm compared to the 2 to 8 mm particle size. On the other hand, when the wood is simply chopped by the industrial chopper but not grinded in laboratory, the extraction performance is much improved, which is a surprising and improved result. Indeed, in seems that by avoiding the grinding step one may both save on grinding energy input and increase the performance of the extraction. Surface examination could be performed to understand the details of why metals in 0 to 8 mm wood squares have a greater solubilization. These observations also facilitated further leaching experiments as there is no need for supplementary grind. Chopped and screened through 8 mm sieve is the selected parameter for the leaching processes below.

### Example 6

### Leaching Process Characteristics

For the purpose of an optional embodiment of the process, the parameters for acid leaching of CCA-treated wood were selected as follows:

1. Wood content: 150 g/L;
2. Acid type and concentration: 0.2 N H₂SO₄;

### 3. Temperature: 75° C.;

4. Reaction time: 6 h; and
5. Wood particle size: <8 mm.

In these conditions, the final leachate is highly concentrated (647 mg As/L, 629 mg Cr/L, 360 mg Cu/L). Organic matter content is high as well and reaches 2,370 mg COD/L. Cost associated to sulfuric acid (65.7 kg H₂SO₄/t) for the treatment of 1 t of dry wood is as low as 7 $. This estimate does not take into account the possibility of recycling the final acid leachate after metal recovery. With so reasonable chemical cost, this acid leaching has very good potential for industrial application. A closed loop system may also further lower operational costs.

### Example 7

### Mass Balance and Characterization of Decontaminated Wood

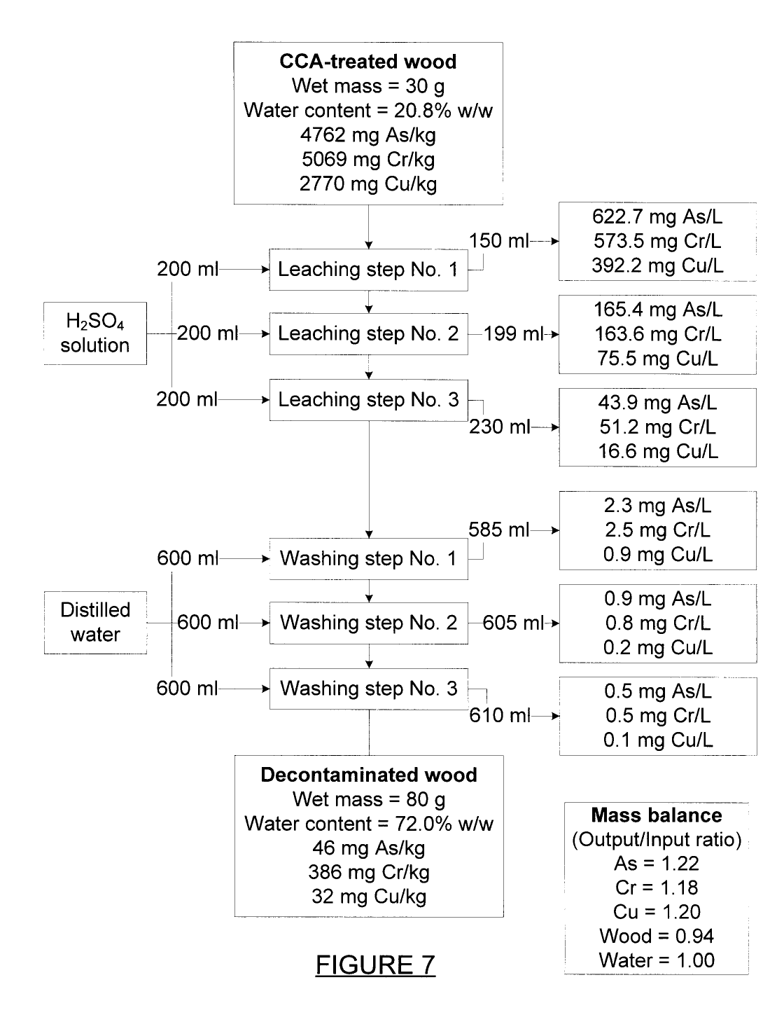

As leaching parameters were identified, the following studies examined the leaching process. A 6-h period is preferable for metals solubilization from CCA-treated wood. In order to insure that all metals are solubilized and extracted from the wood with excellent yields, three short (2 h) leaching steps were tested, instead of only one long (6 h) leaching step. Moreover, the leaching treatment was followed by one, two or three washing steps. Rinsing ensured that extracted metals, which are potentially trapped into wood pores after acid leaching, were expelled into the liquid phase. Washings were done with 600 mL volumes of distilled water. Metals concentrations were measured in each leachate. Furthermore, the wood entering or escaping the system was digested and analysed for metal quantification. The flowsheet of the process including three washing steps is presented in FIG. 7. The operating conditions were: wood content=150 g/L, 0.2N H₂SO₄, T=75° C., reaction time=2 h, particle size from 0.5 to 2 mm, three leaching and three washing steps.

A first observation is that, in the three cases (results not shown), water content in wood increases from 21% to 72%. This is obvious as the wood becomes wet during the first leaching and it means that the wood weight rises from 30 to around 80 g. The leachates obtained after the two first hours of leaching have high metals concentrations, varying between 540 and 623 mg/L, Cr between 500 and 574 mg/L and Cu between 330 and 392 mg/L. The second and third leachates are much less concentrated. As and Cr concentrations are lower than 55 mg/L in the leachate of the third leaching step, where Cu concentration is as low as 17 mg/L.

Also, there seems to be no difference in metals contents in decontaminated wood coming from 1, 2 or 3 washing steps. This indicates that three leaching steps plus one washing step is enough to remove metals trapped inside wood pores. Second and third rinse water concentrations are negligible (lower than 1 mg/L). Final remediated wood contains in average 42 mg As/kg dry wood, 438 mg Cr/kg dry wood and 31 mg Cu/kg dry wood. Compared to initial wood, this represents 99, 91 and 99% As, Cr and Cu extraction.

Availability of the metals in the decontaminated wood was also examined and compared with non-decontaminated wood. Results of TCLP, SPLP and tap water tests are presented in the Table 5. As concentration in TCLP leachates goes from 6.09 to 0.82 mg/L, corresponding to 86% reduction of As mobility, but especially goes from a value larger than the limit of hazardousness for most wastes to a value much lower. For SPLP and tap water test, the availability reduction is 82 and 78%. Cu concentrations are as well reduced in TCLP, SPLP and tap water tests. On the other hand, Cr is bothersome as concentrations in standard tests leachates tend to increase slightly. It should be mentioned that Cr concentrations are already very low in CCA-treated wood and that they stay low in remediated wood: 0.67, 1.16 and 1.20 mg/L in TCLP, SPLP and tap water tests, respectively.

TABLE 5
TCLP, SPLP and tap water leaching test results (mg/L) for CCA-treated wood and decontaminated wood.

| | TCLP | | | SPLP | | | Tap water | | |
|---|---|---|---|---|---|---|---|---|---|
| | As | Cr | Cu | As | Cr | Cu | As | Cr | Cu |
| CCA- | 6.09 ± 0.23 | 0.70 ± 0.05 | 11.82 ± 0.15 | 3.89 ± 0.55 | 0.59 ± 0.11 | 1.27 ± 0.26 | 3.30 ± 0.12 | 0.49 ± 0.03 | 1.07 ± 0.07 |
| treated | | | | | | | | | |
| wood | | | | | | | | | |
| Decont. | 0.82 ± 0.14 | 0.67 ± 0.44 | 0.13 ± 0.05 | 0.69 ± 0.07 | 1.16 ± 0.02 | 0.19 ± 0.00 | 0.72 ± 0.12 | 1.20 ± 0.07 | 0.23 ± 0.03 |
| wood | | | | | | | | | |
| Decrease (%) | 86 | 4 | 99 | 82 | — | 85 | 78 | — | 78 |

Finally, comparing wood metal contents and metals mobility in new CCA-treated wood and remediated CCA-treated wood, this acid leaching process is a great success. Furthermore, this process has reduced cost. Main operational costs for this kind of process are usually chemicals and energy. For this leaching process, acid cost is estimated to approximately 7 $/t of dry wood. Energy costs would be truly low as well because part of the remediated wood could be used as combustible so that heating energy would be almost free. Electricity costs associated with stirring have not been calculated as it depends onto reactor design.

### Example 8

### Electro-Deposition of Copper from CCA-Treated Wood Leachates

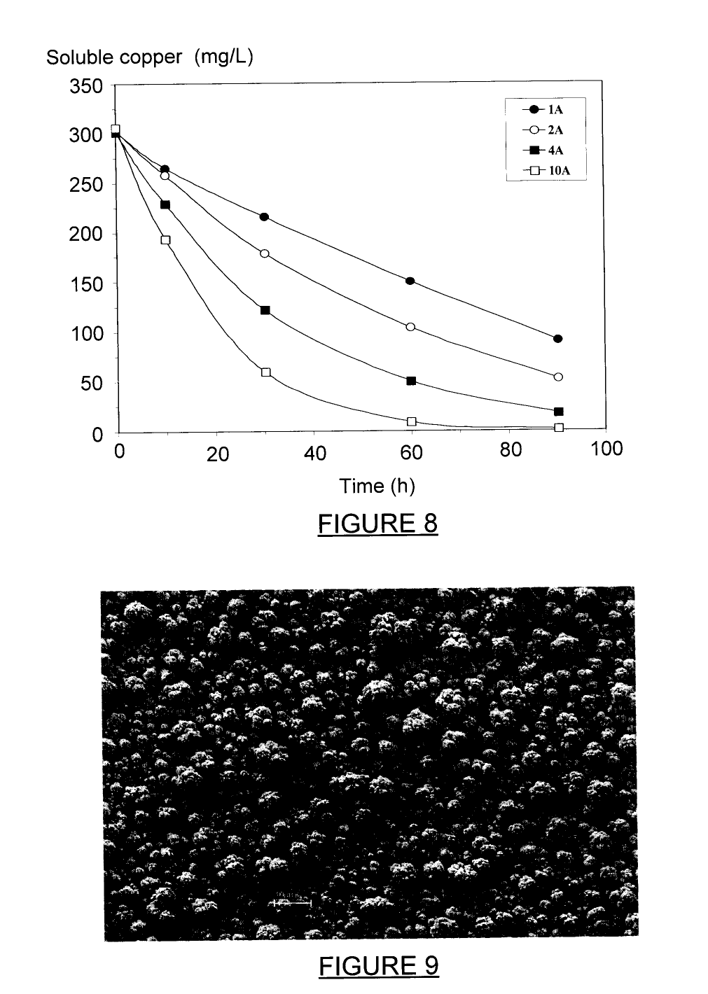

Recovery of diverse metals with various properties like copper, chromium and arsenic can be complex and could require several technologies. As copper has good value on the market, emphasis was made on recovery of pure metallic copper via electrolytic deposition on cathodes. FIG. 8 illustrates copper removal along time scale for various applied intensity, 1, 2, 4 and 10 A (pHᵢ=1.3). As intensity increases, copper deposition increases as well. Copper electrolytic deposition is very efficient. At 10 A, the copper concentration decreases from 306 to 1.3 mg/L. This decrease of the copper concentration corresponds to a removal yield superior to 99%. In addition, chromium concentration during electro-deposition tests stays stable. Chromium is not electrodeposited in theses conditions, even if applied potential is high (3.5 V).

Copper deposition from wood leachates was tested further and during experiments, electrodes became covered by unexpected black deposit meaning that deposited copper was impure. Impurities in copper deposit could come from inherent complex nature of the leachates.

Hence experiments were realised with synthetic metallic solutions to eliminate the uncertainty influence of the organic compounds in the leachates. Synthetic solutions contained As, Cr, Cu and H₂SO₄ to obtain a pH 1.3. Electrolytic deposition experiments again, showed black deposit, thus organics by-products were not black deposit point source. Sulfates were considered as potentially being the point source, so electrochemical experiments were set up with synthetic solution made of hydrochloric acid, chloride salts (CrCl₃, CuCl₂) and arsenic pentoxide. No sulfates were present, nevertheless electro-deposition of this synthetic solution produced black copper deposit.

Another hypothesis was that copper was oxidised on the electrode to form black CuO. MEB were used to analyse deposit structure on the electrode. FIG. 9 shows electrode picture from the MEB examination. Copper represents 86.8±1.6% (mol/mol) of the deposit lying on the electrode. Furthermore, unlike what was expected, chemicals analysis resulted in tiny detected amount (4.4±1.0% (mol/mol)) of oxygen in electrode black deposit. This is not enough to confirm presence of CuO on electrodes. As oxygen has low electronic density, MEB may not detect it easily. To be sure that oxygen results from MEB were reliable, Cu₂O pure crystal were analysed with this instrument. Results are not shown, however they perfectly matched copper and oxygen atomic percentage in Cu₂O structure, meaning that oxygen detection by electronic microscopy is consistent. Therefore oxygen analysis in electrode black deposit is reliable and CuO may be present but is undoubtedly not the main component.

On the other hand, arsenic was present in all four analyses and was the second most common element in the black deposit structure and represents 5.3±0.6% (mol/mol). Arsenic presence in copper structure was puzzling.

A synthetic solution with only copper and chromium in sulfuric acid produced copper colored deposit, but as soon as arsenic was added to the synthetic solution under electrolytic deposition, the deposit became rapidly black. Arsenic seems to be the cause of the black-deposit onset. To determine if arsenic is adsorbed or electrodeposited in the electrode, a test was done with firstly electro-deposition of a bimetallic synthetic solution for 90 min, then addition of arsenic in the electrolytic cell with or without electric current on. When current goes trough the cell, the deposit becomes black but when there is no current, deposit color doesn't change. This means that arsenic deposition on the electrode is electronically governed. Arsenic adsorption hypothesis seems invalid. In the literature there has been observed some electrolytic deposition of arsenic in presence of copper under the form of black spongy-like deposit; Cu₃As production during deposition by interpreting results from cyclic voltametry and Auger electron spectroscopy; Cu₃As presence in black deposit obtained by electrolytic deposition of copper and arsenic in sulfuric acid solution by X-ray diffraction. However, the literature does not agree on the way arsenic is deposited. On one hand, copper arsenide is said to be due to metallic copper and metallic arsenic rearrangement into Cu₃As according to equation 1, while on the other hand copper arsenide is said to deposit electrically from copper and arsenic in solution according to equation 2.

3Cu₍ₛ₎+As₍ₛ₎→Cu₃As₍ₛ₎;Gibbs free energy=−3 kcal/mol [1]

3Cu²⁺+HAsO₂+3H⁺+9e⁻→Cu₃As+2H₂O;E⁰=0.323 V [2]

Further experiments were set up to assess influence of arsenic on copper electrolytic deposition yield. FIG. 10 illustrates copper removal versus arsenic concentration. Copper electro-deposition deposition yielded more than 98%. Without As in the synthetic solution, the deposit formed is pink-brown colored. As arsenic is added to the synthetic solution, even in tiny concentrations, deposit turned out black. Therefore, care should be preferably taken to treat leachates free of arsenic if pure copper deposit is wanted.

The total removal of arsenic from the contaminated solution may also be combined with various other preferred aspects of the process, to obtain synergistic improvements. For instance, the copper recovery can be performed on a specific contaminated solution containing high copper concentration and/or low arsenic concentration, rather than combining all solutions to form an overall contaminated solution to be treated.

### Example 9

### Chemical Precipitation Experiments for Treatment of Synthetic Solutions Containing Arsenic, Chromium and Copper

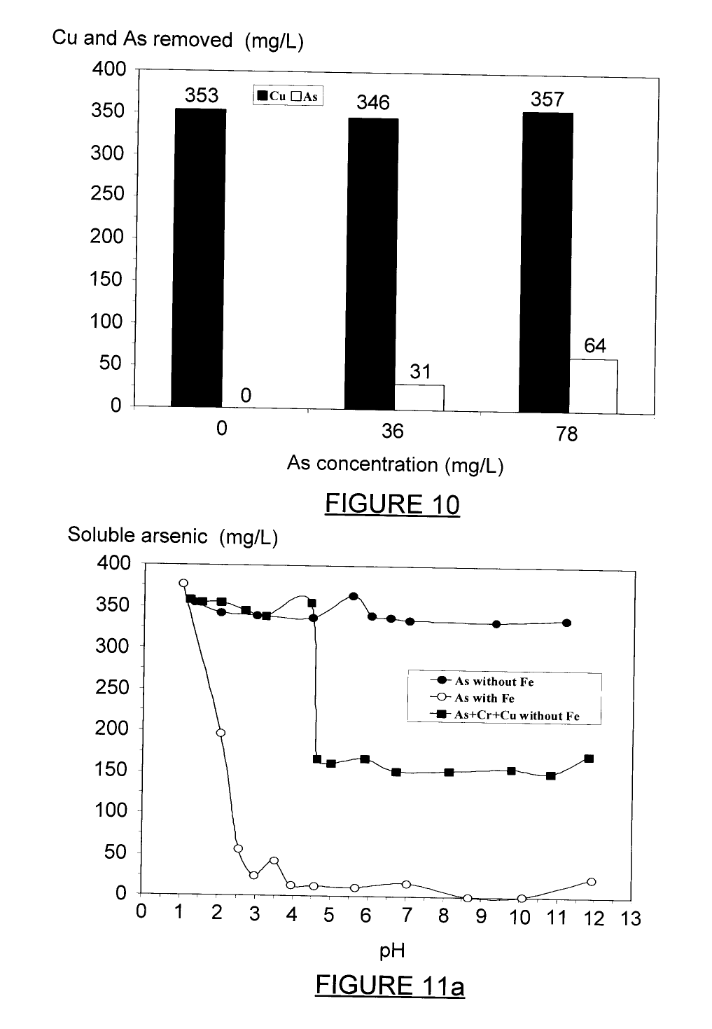

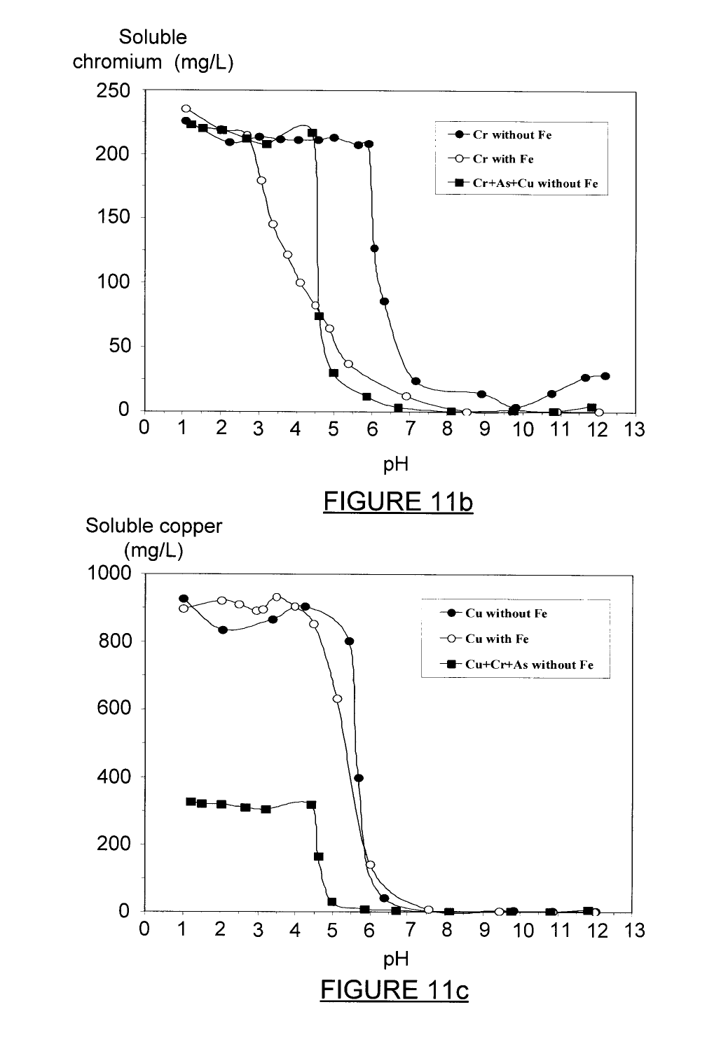

Chemical precipitation was tested for arsenic removal as it is a cheap and efficient arsenic cleansing technique. Influence of pH and presence of a coagulant on arsenic solubility was assessed in synthetic solutions. FIGS. 11a-11c illustrate arsenic, chromium and copper removal as a function of pH in synthetic solutions with or without ferric chloride.

Pentavalent arsenic solubility is not affected by pH increase in synthetic mono-metallic solution and does not precipitate. However, if chromium and copper are present in the synthetic media, arsenic solubility shows a straight drop at pH=4.5. In the same way, chromium solubility drops at pH=6.2 in mono-metallic solution but drops at pH=4.5 in tri-metallic solution. Copper solubility drop is also shifted from pH=6 to pH=4.5 in tri-metallic synthetic solution. This means that presence of metals in the solution influences individual precipitation behaviour of arsenic, chromium and copper. This could be explained by metal-metal interactions as arsenic, chromium and copper are able to form mixed compounds like AsCrO₄, CuHAsO₄.

Arsenic removal is greatly enhanced with addition of a coagulant (e.g. ferric salt) and arsenic solubility curve shows a drop in the pH range 1.5 to 2.8. Arsenic removal goes up to 85% at pH=2.5 and 96% at pH=4. High performance of arsenic coagulation is due in this case to the formation of ferric arsenate. As well, the coagulant influences chromium solubility. Instead of showing a straight drop at pH=6.3 in absence of coagulant, solubility follows a mild slope between pH=2.5 and 7. On the other hand, copper goes nearly unaffected by the presence of iron ions.

In some optional aspects of the process, the treatment conditions may be modified to treat solutions contaminated with one or many different contaminants. For instance, a solution that is treated to remove arsenic and then copper may then be brought to a pH to favor chromium precipitation in particular. Sequential removal of the different metals may thus benefit from tailored pH modifications. Moreover, the sequence of metals removal may be chosen in order to minimize the pH modifications and thus the quantities of corresponding acids or bases to effectuate the pH modifications. The order of acid removal may also be coordinated with and facilitated by the mild acidic leaching conditions.

It should also be understood that coagulants other than the preferred one used in the examples may be employed. For instance, various types of coagulants such as metallic salts may be used. Examples of such metallic salts are aluminium- and lead-based salts. Depending on the type of coagulant used, various different complexes may be formed to allow precipitation.

### Example 10

### Influence of pH on Treatment of CCA-Treated Wood Leachates by Coagulation and Precipitation

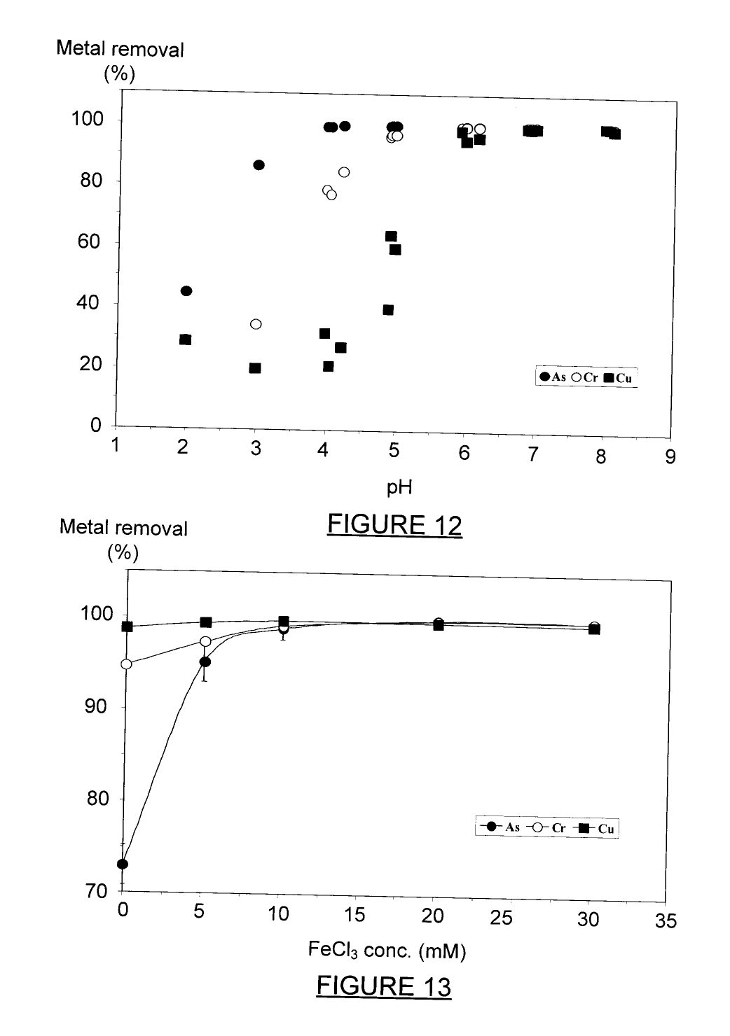

As seen previously, coagulation has high potential for metals extraction from the CCA-treated wood leachates. Because pH is a key parameter in chemical coagulation, tests were carried out along the 2 to 8 pH range. Ferric chloride concentration is fixed at 30 mM. Results are shown in FIG. 12. Complete arsenic extraction (>99%) is achieved at pH=4, while chromium and copper extraction succeeds at pH greater than 6 and 7 respectively. Therefore, increasing the pH from 1.3 in CCA-treated wood leachates to 7 is a preferred option for simultaneous extraction of arsenic, chromium and copper. It allows as much as 99.99% metals removal.

### Example 11

### Influence of Coagulant Concentration on Treatment of CCA-Treated Wood Leachates by Coagulation and Precipitation

Variation of ferric chloride concentration was carried out at pH=7. Results are shown in FIGS. 12. At 20 and 30 mM, coagulation performances are similar, meaning that a concentration of 20 mM is preferred.

### Example 12

### Liquid-Solid Separation after Treatment of CCA-Treated Wood Leachates by Coagulation and Precipitation

Up to this point of experimentation, samples have been withdrawn from the supernatant after decantation. Usually industrial liquid to solid separation implies filtration. Therefore, filtration of the sludge coming from ferric chloride coagulation-precipitation was conducted. The filtrate obtained shows higher metallic concentrations (superior to 70 mg/L of arsenic and chromium and 50 mg/L of copper) than in supernatant. This means that part of the metallic precipitate is able to go through the 1.5 microns pore size filter. As has been observed, coagulation of arsenic with ferric ions can produce very fine particles (0.5 to 20 μm). Particle size should be increased to facilitate filtration. Flocculants are polymers commonly used to help filtration of the sludge. Polymers act as a link between particles such as it forms large particles called “flocs”. The flocculant employed in this experiment is named Percol E10, but a variety of other types could also be used. Addition of the polymer in the sludge caused immediate changes in appearance. Tests were carried out with various polymer concentrations (5, 10 and 20 mg Percol E10/L). Results are shown in Table 6. Metal concentrations in the filtrates are very low and independent of polymer content meaning that Percol E10 flocculation is efficient and metallic particles are retained by the filter. However, the polymer content greatly influences sludge volume. The smaller the sludge volume, the easier the sludge management. Therefore, 5 mg Percol/L is preferred.

TABLE 6
Sludge volume, dry sludge weight, and soluble metal concentrations
in CCA treated wood leachates for various Percol E10 concentrations
after coagulation-precipitation with ferric chloride and NaOH
([FeCl₃] = 20 mM; pH 7).

| | | | Soluble metal | | |
|---|---|---|---|---|---|
| | | | concentrations | | |
| | | | (mg/L) | | |
| | | | As | Cr | Cu |
| 5 | 28 | 2.59 | 0.23 | 0.56 | 1.61 |
| 10 | 38 | 2.65 | 0.24 | 0.58 | 2.07 |
| 20 | * | 3.13 | 0.27 | 0.48 | 1.21 |

* With 20 mg/L of polymer, part of the “flocs” do not settle so volume of the settled sludge can not be measured.

### Example 13

### Mass Balance and Characterization of Metal Sludge During Treatment of CCA-Treated Wood Leachates by Coagulation and Precipitation

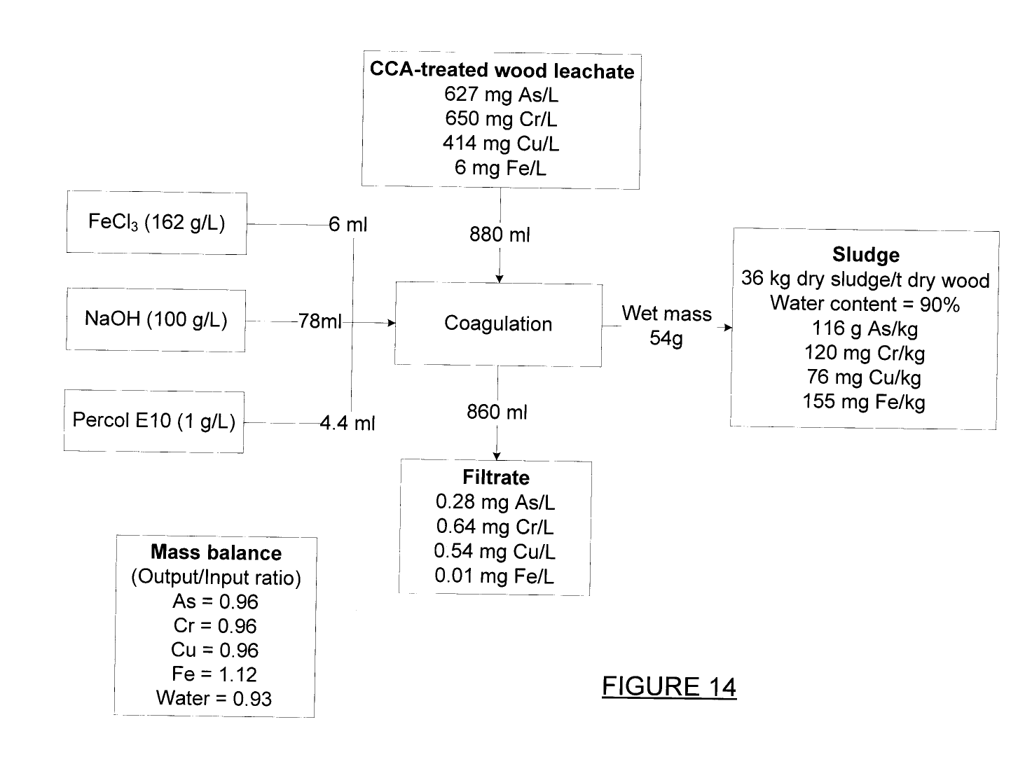

FIG. 14 shows the mass balance for the CCA-treated wood leachate treatment by coagulation-precipitation using ferric chloride and NaOH. Metal sludge characteristics are also presented in this figure. The overall metal removal yields from the CCA-treated wood leachate are as follows: 99.9% As, 99.9% Cr, 99.9% Cu and 99.8% Fe.

### Example 14

### Coagulation and Precipitation of CCA-Treated Wood Leachate Using Calcium Hydroxide

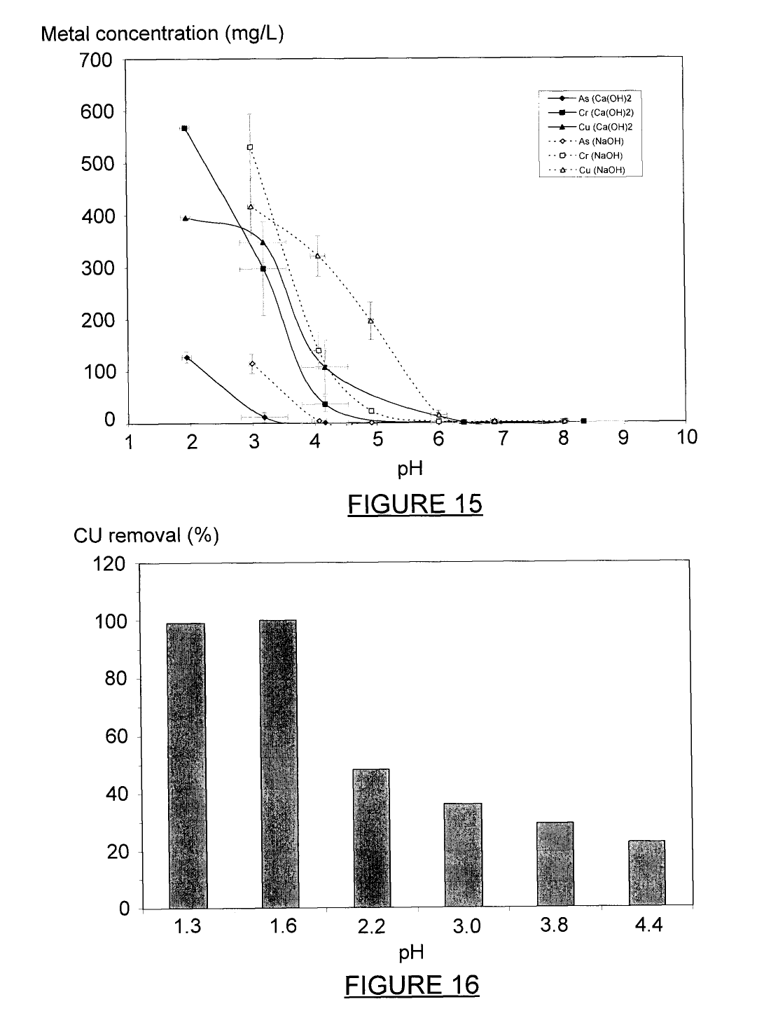

Metals concentrations in calcium hydroxide precipitation effluents versus precipitation pH are shown in FIG. 15. Additionally, this figure presents the results of previous studies, which was conducted with sodium ahydroxide salt. Perception curves obtained with Ca(OH)₂ and Na(OH) have similar shapes except that Ca(OH)₂ curves for arsenic, chromium and copper are shifted on the left hand side toward lower pH for approximately a half pH unit. Precipitation with calcium hydroxide allowed complete arsenic precipitation at pH 3.5, complete chromium precipitation at pH 5 and complete copper precipitation at pH 6.5. Such precipitation enhancement, with respect to the sodium hydroxide precipitation results, may be due to the presence of un-dissolved Ca(OH)₂ particles in the reactor. As has been observed with coarse calcite (CaCO₃) by, arsenic-borne coagulates may coat onto the calcium particles surface and increase the removal efficiency for a given pH.

However, calcium hydroxide is more difficult to handle than sodium hydroxide as it did not dissolve completely in the solution. Thus, the pH adjustments for the precipitation experiments required greater expertise, hence pH standard deviation in Ca(OH)₂ precipitation curves were larger than for NaOH precipitation curves. In addition, the price of Ca(OH)₂ is attractive for chemical engineering process development. Ca(OH)₂ cost on the market is situated around 0.150 US $/kg while NaOH cost is around 0.600 US $/kg. Despite some dissolution and precipitation difficulties, the increased efficiency and lower costs support the pursuit of the decontamination process with Ca(OH)₂ instead of NaOH.

It should also be understood that other types of bases or hydroxides may be used instead of or in addition to Ca(OH)₂ and NaOH. In some instances, Mg(OH)₂ may be employed alone or in combination with another base. Depending on what reagent is used in this step, various different complexes may be formed to help coagulation and precipitation.

### Example 15

### Treatment of CCA-Treated Wood Leachates by Coagulation at pH=4 Followed by Electrodeposition

Selective recovery of metals allows easier recycling and production of valuable materials therefore emphasis was made on arsenic, chromium and copper separation from the leachates. As seen in Example 10, coagulation at pH=4 is attractive as arsenic is entirely separated by coagulation. Hence experiments were carried out with parameters as identified previously in Examples 11 and 12 (20 mM ferric chloride, 5 mg Percol E10/L). Results are shown in Table 7. Coagulation at pH=4 allowed more 99% and 88% removal of arsenic and chromium respectively, while 76% copper was kept solubilized.

TABLE 7
Metal concentrations and removal yields from CCA-treated wood
leachates after coagulation at pH = 4 ([FeCl₃ = 20 mM;
[Percol] = 5 mg/L)

| | Initial conc. | Final conc. | Removal yield |
|---|---|---|---|
| Metals | (mg/L) | (mg/L) | (%) |
| As | 471 | 2.5 ± 2.4 | 99.5 |
| Cr | 346 | 40.2 ± 17.4 | 88.4 |
| Cu | 437 | 332 ± 52 | 24.0 |

Tests were conducted with chemical coagulation of leachates at pH=4 followed by electrolytic deposition at 10 A, but surprisingly, copper electro-deposition yield was low. No pH adjustments were done after hydrometallurgical treatment therefore poor electro-deposition may have been due to pH changes (4.0 instead of 1.3 tested previously). Hence influence of pH was tested. NaOH solution was used to increase leachates' pH up to 1.6, 2.2, 3.0, 3.8 and 4.4. A part of copper is lost by precipitation prior to deposition so copper initial concentration varies from 250 mg/L at pH=1.3 to 185 mg/L at pH=4.4. To get rid of this fluctuation, results are shown as electro-deposition yields against pH onto FIG. 16. It clearly shows that pH has great influence on deposition yields. Copper deposition rate goes from 99% at low pH to 23% at pH=4.4.

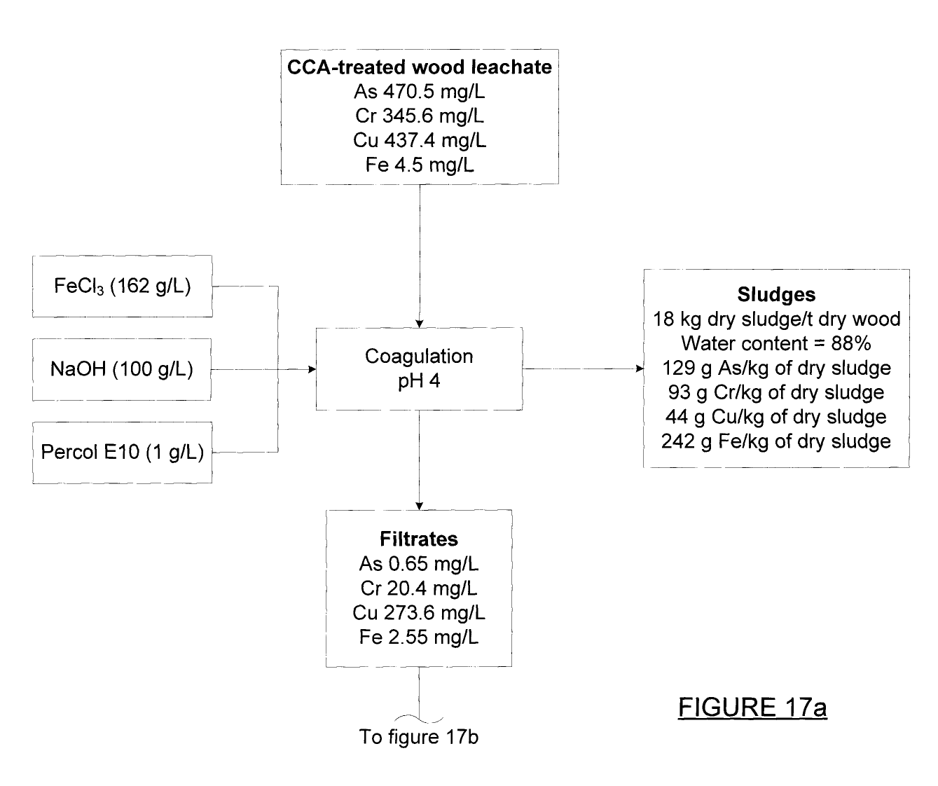

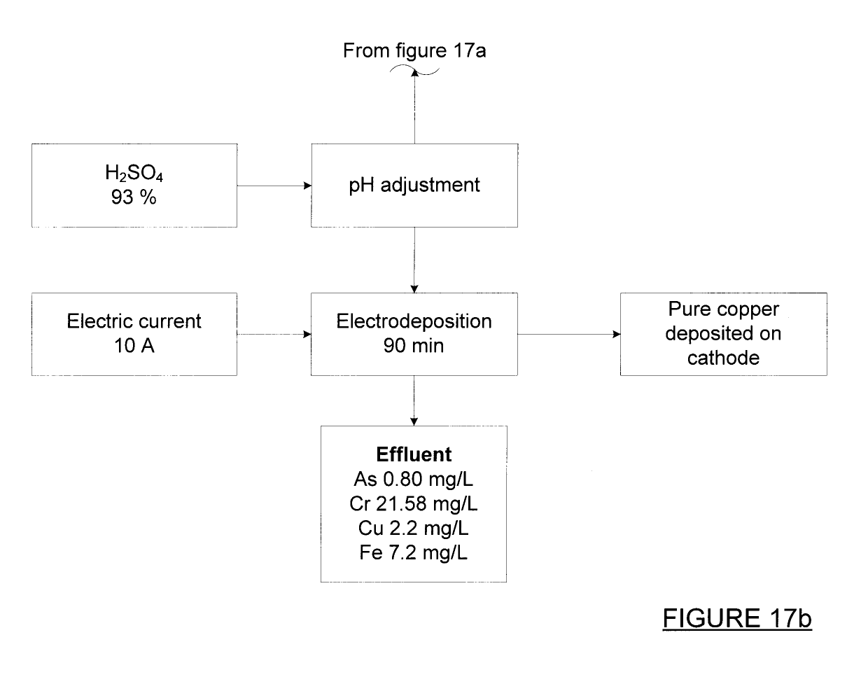

To elaborate a process where electrochemical treatment follows coagulation, pH was re-adjusted in between the two steps. Tests have been conducted with 1200 mL leachates. Effluents from coagulation (at pH=4) were filtered then pH was lowered using sulfuric acid. Electro-deposition was conducted with effluents adjusted at pH=1.3. During electrochemical treatment, electrodes become covered with shinny metallic copper and with pink colored mat copper resembling Cu₂O color. Electro-deposition yielded 99% copper removal. Hence combination coagulation at pH=4 and electro-deposition allows selective recovery of about 75% of pure copper initially contained in CCA treated wood and extraction of 88% chromium and 99% arsenic. FIG. 17 presents a flowsheet of the process including coagulation and electro-deposition steps.

### Example 16

### Ion Exchange Performances Characterization with Batch Mode Experiments

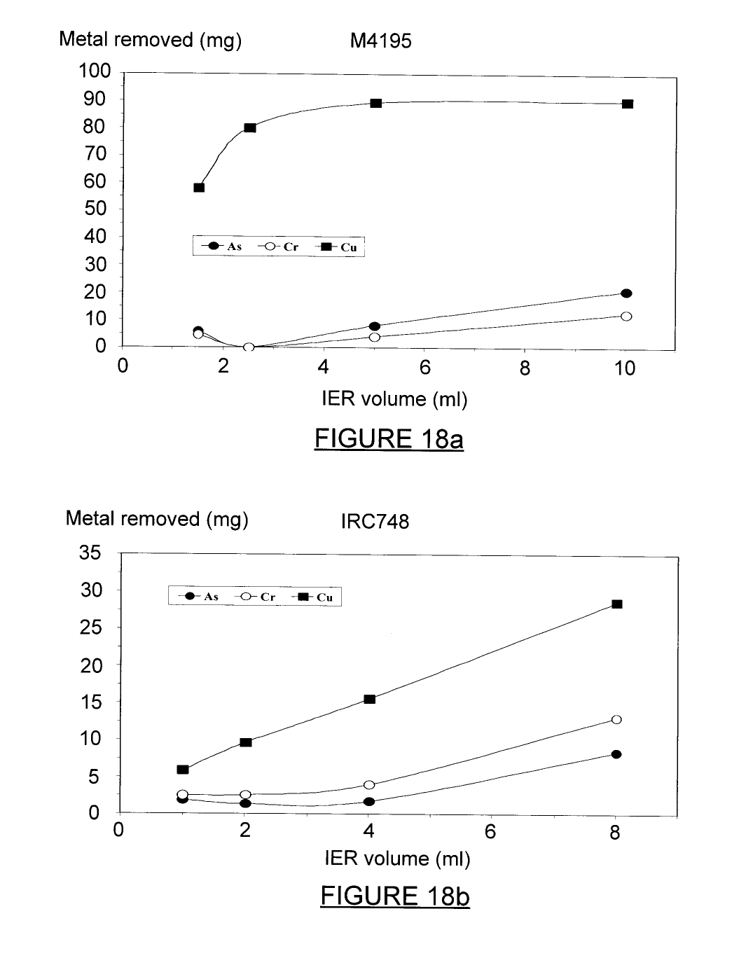

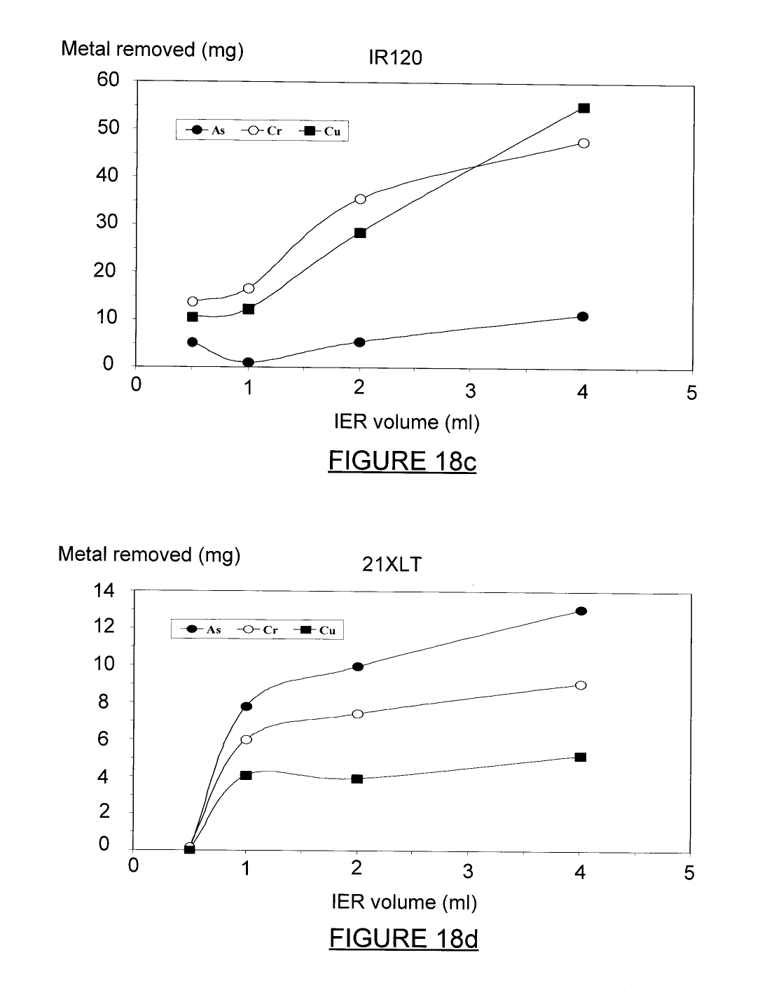

Ion exchange is usually a selective separation technology as resins can be highly specific. Selective separation technology is useful for contaminants extraction. The resins were chosen because of their distinct functional groups. Hence those experiments intended to determine four resins ability for arsenic, chromium or copper extraction from CCA treated wood leachates. Resins extraction capacity has been assessed with batch experiments. FIGS. 18a-18d show results for arsenic, chromium and copper with various ion exchange resins (IER) volumes.

Chelating resins IRC748 and M4195 have relatively high copper extraction capacity and M4195 IER is highly selective. 90 mg Cu are extracted from the leachate while only 21 and 12 mg As and Cr are removed. IR120 is much less selective but has high cation extraction ability. Cu and Cr are very well removed from leachates by this IER. Therefore this 1ER can be used for selective recovery of chromium only if copper was already extracted. On the other hand, 21XLT has higher arsenic extraction capacity than Cr and Cu capacity. This is due to the resin's affinity for anionic species of pentavalent arsenic and hexavalent chromium. Hexavalent chromium can be selectively removed by this resin when arsenic is preliminarily extracted.

Consequently, IER can be used for selective recovery of metals in leachates if used subsequently. An investigation of this is to firstly use M4195 IER for copper extraction, then IR120 IER for trivalent chromium extraction followed by arsenic extraction via coagulation precipitation to end up with hexavalent chromium removable by 21XLT resin.

### Example 17

### Copper and Chromium Removal from CCA-Treated Wood Leachate Using Ion Exchange Resins in Columns

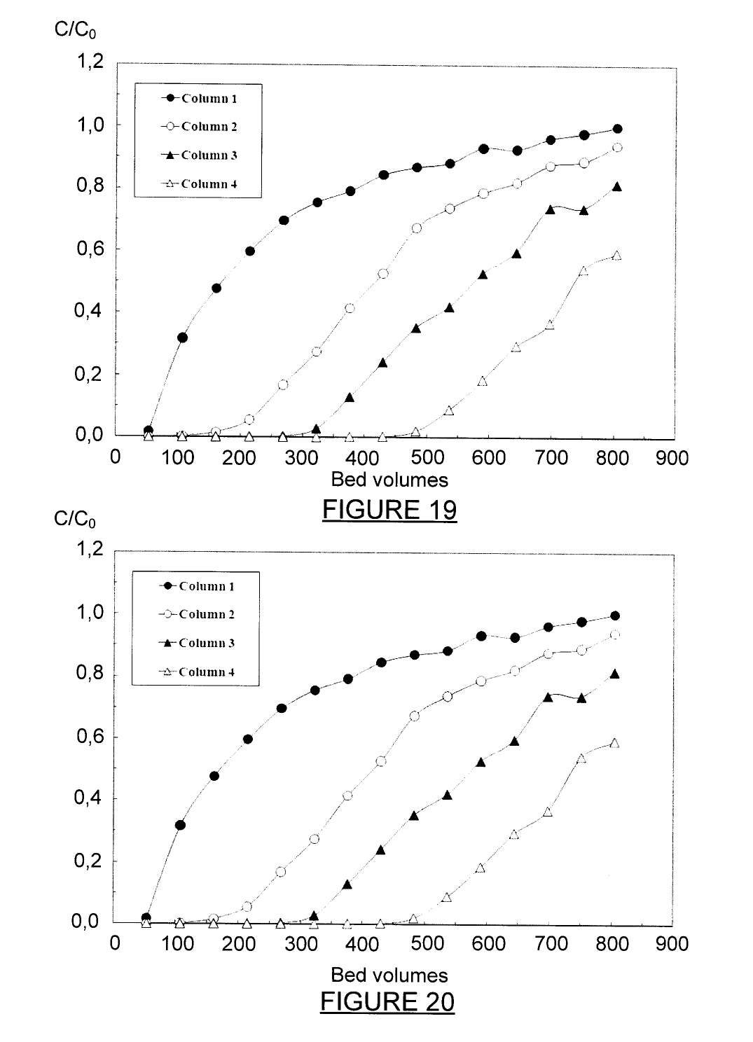

The ratio (C/C₀) of copper concentrations versus the number of Bed Volumes (BV) obtained with the four 56 mL-bed volume columns is presented in FIG. 19. C represents the concentration of copper in the outlet solution and C₀ represents the concentration in the inlet solution. The first column is saturated at the beginning of the experiment whereas breakthrough in columns 2, 3 and 4 appears respectively at 214, 321 and 482 bed volumes. As the M4195 resin adsorbed copper, its colour changed from green to turquoise blue. The initial copper concentration in the leachate was 456 mg/L. The 224 cm³ of M4195 resin contained in the four columns successfully extracted the entire amount of copper from approximately 10 L of leachate. In these conditions, the exchange capacity is 44.1 mg Cu/g in the column. The Dowex M4195 resin has a high exchange capacity combined with a high selectivity for copper. Given these qualities, this resin gave the highest potential for copper recovery in some processes embodiments.

As for IR120 resin, it was used for chromium removal after treatment with the M4195 resin. At this stage, the residual copper and chromium concentrations were respectively 2.37 and 450 mg/L. The ratio (C/C₀) of chromium concentration versus the number of bed volumes is shown in FIG. 20. It is surprising to see that, in the outlet of the fourth column, the chromium concentration is stabilized around 200 mg/L, from 54 to 964 bed volumes. This means that approximately 45% of the Cr is refractory with respect to IR120 adsorption. At first, it seemed that refractory Cr may be in the form of Cr(VI). Consequently, a hexavalent chromium analysis was conducted in various fractions of the effluent. The residual hexavalent chromium concentration measured in the outlet solution of the column stayed under 1 mg/L. The hexavalent chromium concentration was measured at 0.44 mg/L in the IR120 effluent after treatment in 964 bed volumes. Finally, trivalent chromium may be complexed by sulfate ligands available in the leachate in large concentration produced from the sulfuric acid used during the leaching step. Sulfates may cause difficulties because trivalent chromium complexes may not be sorbed by sulfonic cation exchangers.

### Example 18

### Copper and Chromium Elution from Dowex M4195 Resin and Amberlite IR120 Columns

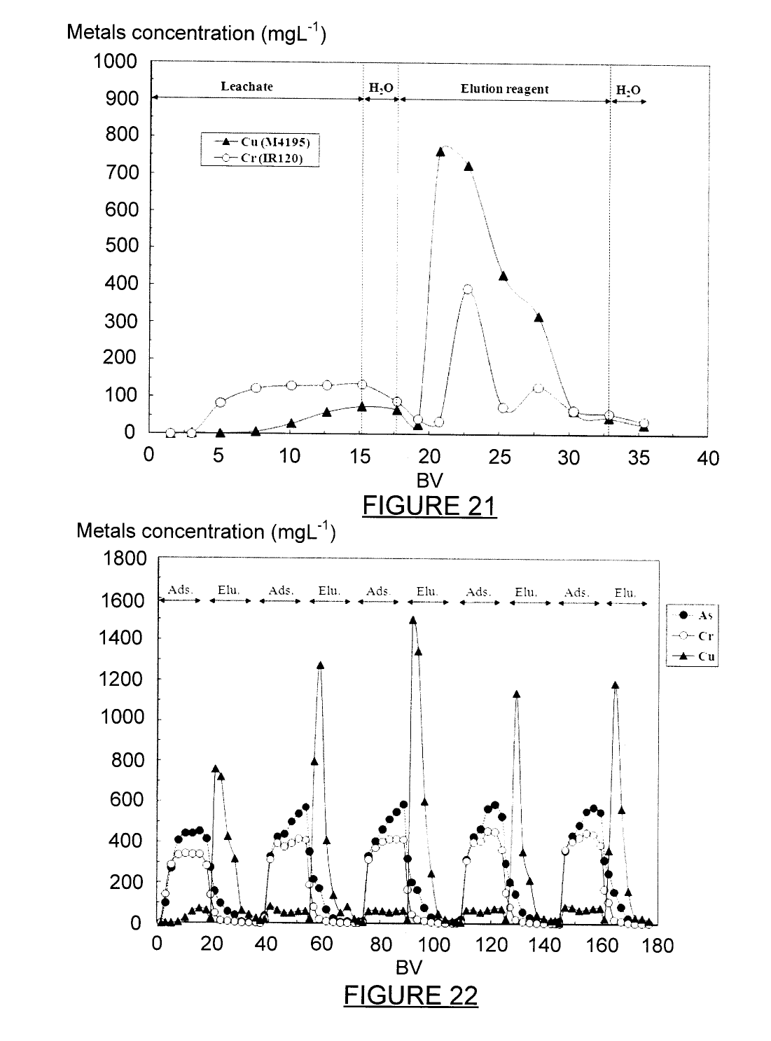

The strong cationic exchanger IR120 is well eluted with H₂SO₄ (10%) as recommended by the manufacturer. In contrast, copper adsorbed onto the M4195 resin is poorly solubilized by sulfuric acid (results not shown) because copper is tightly bound to the nitrogen donor atoms of the bis-picolylamine group and it does not undergo the copper-to-hydrogen ion switch easily. On the other hand, addition of the strong Lewis base NH₄OH (4 M) has been reported as very efficient at solubizing copper. FIG. 21 shows the results of the M4195 elution assay using NH₄OH (4 M) and the IR120 elution assay using H₂SO₄.

The interpretation of the elution curve of copper is straightforward. When the column is fed with leachate, the concentration of copper in the outlet solution is very low (less than 3 mg/L) because it accumulates in the M4195 material until breakthrough appears after 8 bed volumes. When the feed is changed for the NH₄OH solution, an intense blue colour appears in the effluent while the resin goes from turquoise blue to light brown. At this point, the Cu concentration is boosted in the outflow. The maximum measured Cu concentration is 763 mg/L after a 6 min elution, corresponding to 3 bed volumes. Addition of NH₄OH in the column enables the formation of [Cu(NH₃)₄(H₂O)₂]²⁺ which is a dark blue complex. Moreover, it appears that the sulfur concentration in the effluent follows the same trend as the copper concentration and is boosted at the same time. The major source of sulfur in the column is the sulfate ions in the leachate, but these anions are not supposed to adsorb onto the bis-picolylamine functional groups. On the other hand, MINEQL+ (version 4.5) simulations show that the major form of Cu(II) in the leachate solution is CuSO₄(aq). This indicates that sulfate may undergo co-sorption with Cu onto M4195 uncharged functional groups, as well as co-desorption in the presence of NH₄OH.

A similar elution profile is observed for chromium in the IR120 column, except that a fraction of chromium is not adsorbed by the sulfonic-group-bearing material as it was already observed in previous adsorption experiments. The maximum measured chromium concentration is 394 mg/L after 5 bed volumes. The blackish resin becomes brown as chromium ions are displaced by hydrogen ions during elution.

Table 8 gives metal concentrations in column effluents during adsorption, elution and rinsing steps. During the adsorption process 96% of the copper was removed, while 94% of the copper was eluted using M4195 as the sorbent. This Dowex chelating resin is especially efficient for both adsorption and elution processes. On the other hand, the IR120 chromium adsorption yield is only 68% because of the refractory chromium fraction, whereas elution is effective (81%) with sulfuric acid after 15 bed volumes. Moreover, the by rinsing with water between the elution and adsorption steps causes the release of a significant amount of chromium, meaning Cr recovery could be improved by elution flow rate optimisation.

Table 8 shows that M4195 and IR120 effluents obtained after elution contain arsenic and iron to some extent. The M4195 elution effluent is composed of 70% Cu, 21% As, 7% Cr and 1% Fe. The IR120 elution effluent is composed of 57% Cr, 25% Fe, 17% As. IR120 has a very high affinity for trivalent iron. This resin is able to extract iron from leachates, even if it is present at a low concentration, and releases it during elution. On the other hand, M4195 has lower affinity for trivalent iron than for copper so that iron is present at a very low concentration in elution effluent. Arsenic presence in the elution effluent is surprising because arsenic is expected neither to react with sulfonic nor bis-picolylamine groups consequently, it should not have bonded with the resin.

TABLE 8
Metals concentration in M4195 and IR120 effluents during adsorption
and elution and balance between metals coming out and in the column
(Δ = ([metals]ₒᵤₜ − [metals]ᵢₙ) × Vol.;
Flow rate = 10 mL/min; BV = 19.8 mL)

| | |
|---|---|
| M4195^{a} | IR120^{b} |

| | | Outlet | | Outlet | |
|---|---|---|---|---|---|
| | | conc. | Δ | conc. | Δ |
| | | (mg/L) | (mg) | (mg/L) | (mg) |
| Adsorption | As | 290 | −50.4 | 389 | −20.8 |
| | Cr | 257 | −24.9 | 108 | −69.5 |
| | Cu | 12.3 | −96.3 | 0.7 | −0.1 |
| | Fe | 60.2 | 15.9 | 0.7 | −1.7 |
| | S | 1922 | −367.7 | 2756 | −114.4 |
| Rinsing | As | 554 | 27.7 | 438 | 21.9 |
| | Cr | 419 | 20.9 | 140 | 7.0 |
| | Cu | 98.4 | 4.9 | 0.1 | 0.0 |
| | Fe | 97.5 | 4.9 | 0.3 | 0.0 |
| | S | 32.2 | 160 | 2677 | 134 |
| Elution | As | 91.7 | 27.5 | 56.0 | 16.8 |
| | Cr | 31.2 | 9.4 | 185 | 55.4 |
| | Cu | 301 | 90.2 | 0.4 | 0.1 |
| | Fe | 5.3 | 1.6 | 82.9 | 24.9 |
| | S | 2266 | 680 | 38057 | 11417 |
| Rinsing | As | 4.1 | 0.2 | 2.6 | 0.1 |
| | Cr | 2.4 | 0.1 | 46.8 | 2.3 |
| | Cu | 27.9 | 1.4 | 0.1 | 0.0 |
| | Fe | 0.3 | 0.0 | 9.5 | 0.5 |
| | S | 123 | 6.2 | 45500 | 2275 |

^{a}M4195 feed: [As] = 608 mg/L, [Cr] = 530 mg/L, [Cu] = 456 mg/L, [S] = 3148 mg/L, [Fe] = 7.3 mg/L.
^{b}IR120 feed: [As] = 579 mg/L, [Cr] = 521 mg/L, [Cu] = 5.1 mg/L, [S] = 3138 mg/L, [Fe] = 6.4 mg/L.

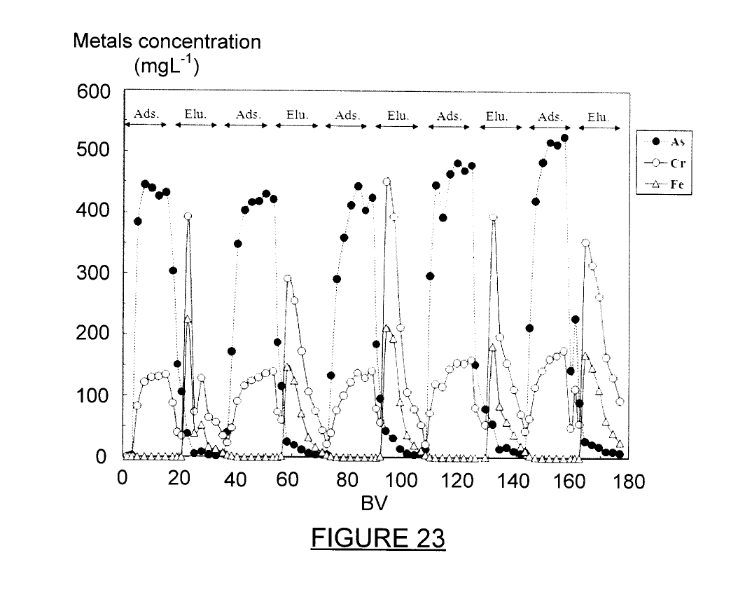

FIGS. 22 and 23 show successive adsorption and elution profile of M4195 and IR120 resins. The copper outlet concentration in M4195 column is very low during the adsorption phases but is sharply eluted during the desorption phases. In contrast, arsenic and chromium concentrations in M4195 effluents are high during adsorption phases. This means that these metals are not well retained and go quickly through the M4195 column. Moreover, during the elution step with NH₄OH used as column feed, the arsenic concentration in the column outlet decreases slowly. Arsenic takes longer to escape the column than chromium. The shape of the curve may be a sign of arsenic bulk diffusion into the M4195 resin. As a consequence, the elution effluent contains arsenic, as it was observed in previous experiments. Arsenic presence in effluents is undesired but diffusion can be reduced by decreasing the inlet flow rate.

In FIG. 22, chromium shows the same adsorption and elution pattern in the five sequences. A fraction of chromium is not retained by the IR120 material, whereas the extracted chromium exits the column during strong acid elution. As well, the iron profile is noteworthy. The iron concentration peaks at the same time as that of chromium. Both trivalent metals are scattered onto the resin until the column is fed with a strong acid when both metals are solubilized. This confirms that iron concentration in the elution effluent is high. Moreover, arsenic diffusion in IR120 is much less important than in the M4195 column.

### Example 19

### Treatment of CCA-Treated Wood Leachate Using M4195 Resin Followed by IR120 Resin and Coagulation

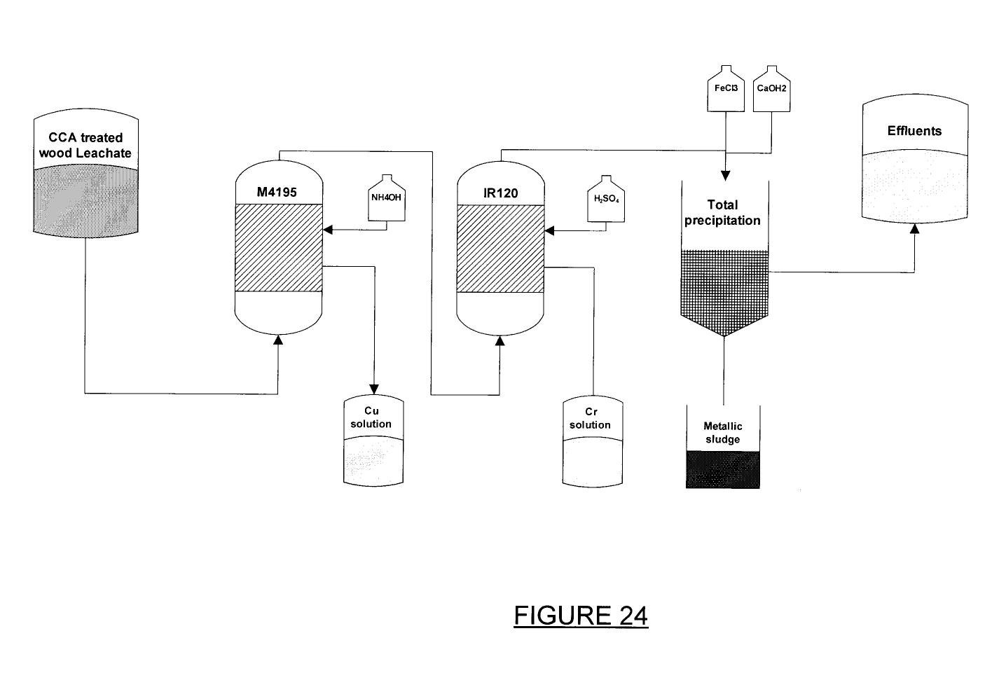

Treatment using the M4195 resin followed by IR120 allows for 96% and 68% extraction of copper and chromium, respectively. After passing CCA-treated wood leachate through M4195 and IR120 columns, the effluent contained 619 mg As/L, 227 mg Cr/L and 0.35 mg Cu/L. In order to enhance chromium removal and extract arsenic, a coagulation-precipitation step is conducted using Ca(OH)₂. A previous study showed that raising the pH up to 5.7 with Ca(OH)₂ in presence of ferric chloride enables arsenic and chromium removal from CCA-treated wood leachate (results not shown). Duplicate tests were conducted with M4195+IR120 effluent and resulted in average concentration values of 0.8 mg As/L, 0.7 mg Cr/L and 0.1 mg Cu/L. Hence, precipitation is an efficient finishing treatment for arsenic, chromium and copper removal after using an ion exchange resin. FIG. 24 shows a schematic drawing of the set-up of the overall process that can be used for treatment of CCA-treated wood leachate.

M4195 and IR120 treatment of CCA-treated wood leachate followed by coagulation and precipitation treatment with ferric chloride at pH 5.7 fulfill Quebec, Canada requirements for wastewater release. This demonstrates the potential application of this process on the industrial scale.

### Example 20

### Recirculation of Precipitation-Coagulation Effluent Back into the Leaching Reactor for CCA-Treated Wood Metals Extraction

Recirculation experiment assessed the possibility of recycling the process water in order to decrease water needs. The decontamination process included a leaching step conducted with sulfuric acid, which solubilized the metals from the wood into the leachate, followed by a pH 7 coagulation-precipitation step in order to immobilise metals into sludge for further safe disposal. Because this treatment produced neutral pH effluents, the effluent needed to be re-acidified with sulfuric acid before being reused as a leaching solution. Efficiency of the leaching and precipitation-coagulation step was measured, as well as the water, wood and metals balance.

Each leaching steps were conducted with a constant volume of Acid Leaching Solution, ALS, of 1400 mL. The mixtures in leaching reactors were filtered to get the Acid Leachates, LA, which were then precipitated and filtered to obtain the Precipitation Effluent, PE. The wood wetted during the leaching step, and the humidity content in the wood increased from 9.8% to 62% or 65% after the decontamination treatment, depending on the loops. Hence, leachate volume varied between 940 and 980 mL. Calcium hydroxide and ferric chloride quantities used for the coagulation-precipitation step were adjusted with the leachate volume to get 19 mM of ferric chloride and a pH around 7. Precipitation-coagulation was carried out in the same conditions along the whole experiment with filtration used for liquid-sludge separation. Sludge produced by leachate precipitation varied from 17.1 to 20.1 g on a dry basis with humidity percent varying from 74 to 78. However, no tendencies were observed for the sludge production, it did not seem to increase or decrease along the experiment. Moreover, the volume of precipitation effluent also varied along the loops. Hence the recycled effluent proportion in the next loop-acid leaching solution varied. The bulk proportion of recycled effluent (PE_{Ln}) contained in the acid leaching solution (ALS_{Ln+1}) is indicated in the Table 9 and varied between 80 and 86% for the loops L2 to L5.

TABLE 9
Experimental parameters for the five loops including the Acid Leaching
Solution (ALS) volume and pH, the Remediated Wood (RW) wet mass
and humidity, the Acid Leachate (AL) volume, the Metallic Sludge
(MS) wet mass and humidity, the Precipitation Effluent (PE) volume
and the bulk proportion of PE contained in ALS

| | ALS | | RW wet | RW | AL | MS wet | MS | PE |
|---|---|---|---|---|---|---|---|---|
| | volume | ALS | mass | humidity | volume | mass | humidity | volume |
| Loop | (mL) | pH | (g) | (%) | (mL) | (g) | (%) | (mL) |
| L1 | 1400 | 1.45 | 347 | 65 | 940 | 1477 | 77 | 1160 |
| L2 | 1400 | 1.33 | 340 | 62 | 960 | 1475 | 75 | 1200 |
| L3 | 1400 | 1.27 | 347 | 65 | 960 | 1474 | 74 | 1180 |
| L4 | 1400 | 1.29 | 347 | 65 | 965 | 1478 | 78 | 1120 |
| L5 | 1400 | 1.28 | 340 | 62 | 980 | 1476 | 76 | 1220 |

Table 10 presents the water balance in the process for the five loops. Input water includes the water contained in the initial treated wood, the first acid leaching solution, ALS_{L1}, which is constituted of distilled water, the addition of distilled water into the precipitation effluent to complete the volume up to 1400 mL for the next leaching step and finally the water contained in the ferric chloride, calcium hydroxide solutions or concentrated sulfuric acid (93%). On the other hand, water output includes the water contained in the remediated wood and in the sludge and the remaining precipitation effluent from the fifth loop. The main water input in the system occurs while adding the calcium hydroxide (50 mg/L) solution. The other important water source comes from completing the precipitation effluent volume with distilled water up to the desired leaching solution volume. The main water outcome from the recirculation system comes from the humidity content in the remediated wood. Actually, the wood humidity went from 9.8% to an average of 63.8% by using filtration over a vacuum pump to separate the leachate and the remediated wood. Hence, there is a differential of 54% humidity, which induces a process water loss through wood wetting of 540 L/t of treated wood. The adaptation of this decontamination process up to an industrial scale could benefit from an improvement of the liquid to solid separation technology to reduce humidity content in the decontaminated wood and reduce the water loss.

TABLE 10
Water volume balance in the five loops-recirculation experiment

| | Water Input (mL) | | | | | | Water output (mL) | | |
|---|---|---|---|---|---|---|---|---|---|
| Loop | TW | ALS | H₂SO₄ | FeCl₃ | Ca(OH)₂ | H₂O | RW | MS | PE |
| L1 | 20.6 | 1400 | 0.5 | 6.4 | 260 | — | 225 | 57 | 0 |
| L2 | 20.6 | 0 | 0.5 | 6.5 | 275 | 240 | 211 | 60 | 0 |
| L3 | 20.6 | 0 | 0.5 | 6.5 | 280 | 200 | 225 | 57 | 0 |
| L4 | 20.6 | 0 | 0.5 | 6.5 | 290 | 220 | 225 | 64 | 0 |
| L5 | 20.6 | 0 | 0.5 | 6.6 | 285 | 280 | 211 | 55 | 1220 |
| Sum | 102.9 | 1400 | 2.7 | 32.5 | 1390 | 940 | 1097 | 294 | 1220 |
| Total Input | | | | 3868 | | | | | |
| Total Output | | | | | | | | 2612 | |
| Out/In | | | | | 68% | | | | |

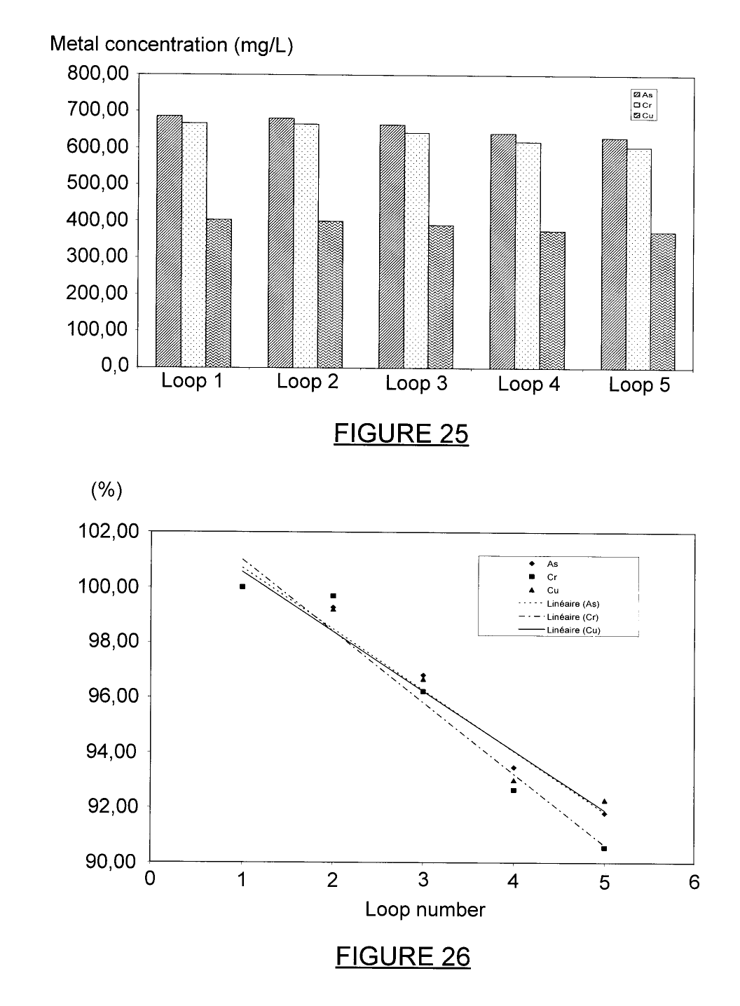

The first loop acid leaching solution was made of distilled water with acid sulfuric while the following acid leaching solutions were made partly with recycled coagulation-precipitation effluent, sulfuric acid, and distilled water to complete the leaching solution volume up to 1400 mL. Sulfuric acid addition was kept constant and equal to 5.5 mL/L. The first leachate, WL_{L1}, contained 686 mg As/L, 667 mg Cr/L and 403 mg Cu/L. Next leachate concentration decreased over the four subsequent loops. In other word, the leaching step of the first loop remained the most efficient. FIG. 25 presents the evolution of metals concentration in leachate. Efficiency loss is slow. If we account for 100% metals solubilization efficiency during the first loop, then the fifth leaching step solubilized 91.8% of the arsenic contained in the first leachate, 90.6% of chromium and 92.3% of copper. FIG. 26 shows the arsenic, chromium and copper leaching yield. Linear regression of the leaching efficiency along the recirculation indicates a 2.2% efficiency loss per loop for arsenic (R²=0.97) and copper (R²=0.95) and 2.6% efficiency loss per loop for chromium (R²=0.96). Chromium solubilization was slightly more sensitive to the leaching conditions and the loss of efficiency was somewhat quicker.

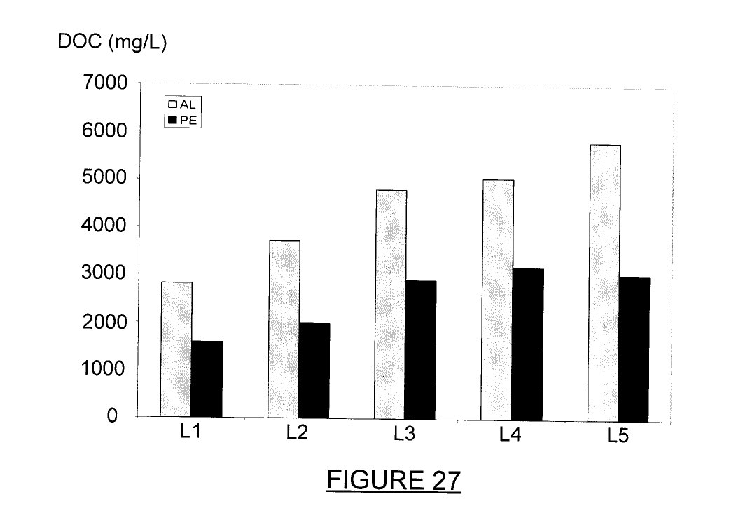

DOC in the leachates are presented in FIG. 27. In the first fraction AL_{L1}, the DOC content was 2,823 mg/L and it increased up to 5,813 mg/L in the fifth loop. DOC increased regularly along the recirculation experiment. Linear regression on the DOC content elevation (not shown) predicted a 730 mg DOC/L increase per loop (R²=0.9664). Hence, dissolved organic carbon tended to accumulate in the system at the tested conditions. DOC elevation may explain the metals solubilization decrease along the loop. It has also been found that there is a correlation between arsenic, chromium, copper and organic compounds (probably lignin) solubilization from the wood in the case of sulfuric acid leaching. The solubilization reaction tends to follow its chemical equilibrium. This equilibrium is influenced, amongst other parameters, by the concentration of the dissolved species in the reactor. The higher the dissolved species concentration in a media, the lower the solubilization. In the same way, high dissolved carbon content (i.e. wooden by-products from previous leaching treatment) may shift the organic compounds solubilization equilibrium, to some extent, toward lower DOC dissolution and fewer metals release in the leachate. Thus, increasing DOC content in acid leaching solution may be responsible for the 2% metals solubilization reduction.

Table 11 presents the arsenic, chromium, copper and sulfur concentration before (AL) and after the precipitation step (PE) for the five recirculation loops. The precipitation treatments were conducted at pH approximately 7 (between 6.90 and 7.12) with 17 mM ferric chloride to enhance metals removal and 50 mg/L calcium hydroxide solution to increase the pH as described in previous chapter. Precipitation treatment was especially efficient and led to more than 99% As, Cr and Cu removal. pH increases were thought to produce ferric, chromium and copper hydroxide salts Fe(OH)₃, Cr(OH)₃ and Cu(OH)₂. However, evidence was found of co-precipitation of iron and arsenic (FeAsO₄.2H₂O), chromium and copper (CuCrO₄), copper and arsenic (Cu₃(AsO₄)₂.2H₂O) and chromium and arsenic (CrAsO₄). Moreover, arsenic elimination in presence of ferric chloride with pH elevation may be due to arsenic adsorption over ferric hydroxide. Precipitation efficiency did not decrease over the recirculation loops; hence the precipitation treatment is not sensitive to the chemical environment changes in the system along the loops. Precipitation effluents contained, in average, 2.2 mg As/L, 2.7 mg Cr/L, 1.9 mg Cu/L and 3.8 mg S/L.

TABLE 11
Metals concentrations in Acid Leachate (AL) and Precipitation Effluent
(PE) with pH and removal yields of the precipitation step

| | Precipitation | | AL | PE | Removal |
|---|---|---|---|---|---|
| Loop | pH | Metals | (mg/L) | (mg/L) | (%) |
| L1 | 6.93 | As | 686 | 1.4 | 99.8 |
| | | Cr | 667 | 1.7 | 99.7 |
| | | Cu | 403 | 1.4 | 99.7 |
| | | S | 2569 | 2.0 | 99.9 |
| L2 | 7.12 | As | 681 | 2.7 | 99.6 |
| | | Cr | 665 | 3.0 | 99.6 |
| | | Cu | 400 | 2.0 | 99.5 |
| | | S | 3144 | 3.8 | 99.9 |
| L3 | 6.90 | As | 664 | 2.3 | 99.7 |
| | | Cr | 642 | 3.0 | 99.5 |
| | | Cu | 390 | 2.0 | 99.5 |
| | | S | 2935 | 3.3 | 99.9 |
| L4 | 7.03 | As | 641 | 3.3 | 99.5 |
| | | Cr | 618 | 3.9 | 99.4 |
| | | Cu | 375 | 2.5 | 99.3 |
| | | S | 2742 | 4.7 | 99.8 |
| L5 | 6.95 | As | 630 | 1.4 | 99.8 |
| | | Cr | 604 | 2.2 | 99.6 |
| | | Cu | 372 | 1.6 | 99.6 |
| | | S | 2680 | 5.2 | 99.8 |

Furthermore, sulfur content was especially high in the acid leachate due to the significant addition of sulfuric acid prior to the leaching step and ranged between 2570 and 3140 mg S/L. However, sulfur content was 99% reduced as well as As, Cr and Cu because of the CaSO₄ precipitation observed in one of the above example sections. This is especially interesting as it prevents sulfate ions accumulation in the recirculation system. Moreover, precipitation allowed carbon removal from the leachate up to some extent. Carbon precipitation yields were respectively 43%, 46%, 40%, 37% and 48% for the loop L1, L2, L3, L4 and L5. DOC removal increased from 1230 mg/L to 2770 mg/L, thus carbon elimination via precipitation increased with increasing DOC content. However, the DOC content after the precipitation treatment still remained high. The precipitation step limited the carbon accumulation but did not avoid it completely and, as seen previously, it could hinder the metals and wood components solubilization during the following leaching step.

It should be understood that the above embodiments, examples and experiments are given here as being optional and non-limitative. Indeed, many aspects of the processes of the present invention may be modified while keeping within what has actually been invented. For instance, the type of inorganic acid, preservative contaminant, coagulant, flocculant, pH reducing or augmenting reagents; the process contacting, separation or recovery techniques, and so on, may be modified. Such optional aspects of the processes may also be combined with other optional aspects, even though such combinations may not have been explicitly set out herein, to obtain further embodiments of the present invention.

1-73. (canceled)

74. A process for decontamination of wood material contaminated with a preservative comprising contaminants, the contaminants comprising copper, the process comprising:
contacting the wood material with water and an inorganic acid at a concentration between about 0.05 N and about 0.8 N at a temperature lower than about 100° C., to solubilise at least a portion of the copper present in the wood material, thereby producing a contaminant-rich solution and contaminant-poor wood material; and
separating the contaminant-rich solution from the contaminant-poor wood material.

75. The process of claim 74, wherein the inorganic acid is at a concentration between about 0.1 N and about 0.5 N.

76. The process of claim 75, wherein the inorganic acid is at a concentration of about 0.2 N.

77. The process of claim 74, wherein the inorganic acid comprises sulfuric acid, hydrochloric acid, nitric acid, a used acid or a recycled acid or a combination thereof.

78. The process of claim 74, wherein the contaminated wood material comprises contaminated wood chips or wood pieces.

79. The process of claim 74, wherein the wood material and the water are provided according to a ratio between about 20 g/L and about 200 g/L.

80. The process of claim 74, wherein the contacting step is performed by soaking the contaminated wood material for a reaction time between about 0.5 hours and about 24 hours.

81. The process of claim 74, wherein the preservative is:
chromated copper arsenate (CCA);
acid copper chromate (ACC);
copper borate (ACB);
ammonium copper zinc arsenate (ACZA);
alkaline copper quaternary ammonium (ACQ);
copper azole (CA);
copper xyligen (CX-A); or
micronized copper systems (MiCu); or
a combination thereof.

82. The process of claim 74, further comprising:
washing the contaminant-poor wood material to remove residual contaminants therefrom, thereby producing treated wood material and a spent washing solution; and
separating the treated wood material from the spent washing solution.

83. The process of claim 82, wherein the washing comprises rinsing or soaking the contaminant-poor wood material in at least one washing step, using water, an acidic washing liquid or an alkaline washing liquid for each of the at least one washing step.

84. The process of claim 83, further comprising treating the contaminant-rich solution or the spent washing solution or a combination thereof, to recover at least one of the contaminants therefrom, the treating comprising chemical precipitation, electro-deposition, electro-coagulation, ion exchange, solvent extraction, membrane separation or adsorption or a combination thereof.

85. The process of claim 84, wherein the contaminants comprise copper, chromium and arsenic.

86. The process of claim 84, wherein the treating comprises contacting the contaminant-rich solution with a coagulant at a pH favoring precipitation of arsenic, chromium and copper.

87. The process of claim 86, wherein the treating comprises:
removing at least the arsenic from the contaminant-rich solution to produce a copper-concentrated solution;
performing electro-deposition on the copper-concentrated solution to recover the copper.

88. The process of 87, wherein the removing of the arsenic comprises:
contacting the contaminant-rich solution with a coagulant at a pH favoring both precipitation of the arsenic and continued solubility of the copper; and
separating the precipitated arsenic to produce the copper-concentrated solution.

89. The process of claim 88, wherein the coagulant is a metallic coagulant and the pH favoring both precipitation of the arsenic and continued solubility of the copper is between about 3 and about 5.

90. The process of claim 84, wherein the treating comprises removing the arsenic and substantially reducing the chromium from the contaminant-rich solution to produce the copper-concentrated solution, comprising:
contacting the contaminant-rich solution with a coagulant at a pH favoring precipitation of the arsenic and the chromium and continued solubility of the copper; and
separating the precipitated arsenic and chromium to produce the copper-concentrated solution.

91. The process of claim 84, wherein the treating comprises:
contacting the contaminant-rich solution with an ion exchange or chelating resin favoring both copper extraction and continued chromium and arsenic solubility, to produce a copper-bearing material and a chromium-arsenic-rich solution; and
separating the copper-bearing material from the chromium-arsenic-rich solution; and
recovering the copper from the copper-bearing material.

92. A process for selectively extracting copper from a contaminated solution comprising copper, chromium and arsenic, comprising:
contacting the contaminated solution with a coagulant at a pH favoring precipitation of the arsenic and continued solubility of the copper;
separating the precipitated arsenic and chromium to produce a copper-concentrated solution; and
recovering the copper from the copper-concentrated solution.

93. A process for selectively extracting copper from a contaminated solution comprising copper, chromium and arsenic, comprising:
contacting the contaminated solution with an ion exchange or chelating resin favoring both copper extraction and continued chromium and arsenic solubility, to produce a copper-bearing material and a chromium-arsenic-rich solution;
separating the copper-bearing material from the chromium-arsenic-rich solution; and
recovering the copper from the copper-bearing material.
